(19) United States
(12) Patent Application Publication
(10) Pub. No.: US 2017/0323410 A1
(43) Pub. Date: Nov. 9, 2017

(54) SYSTEMS, METHODS AND ARCHITECTURE FOR SAFEGUARDING AGAINST BULLYING AND TERRORISM WHILE SENDING SECURE, SCHEDULED, COMPLEX MESSAGES, CORRESPONDING FUNDS AND PHYSICAL GIFTS OVER THE INTERNET

(71) Applicant: John J. Donovan, Hamilton, MA (US)

(72) Inventor: John J. Donovan, Hamilton, MA (US)

(21) Appl. No.: 15/412,932

(22) Filed: Jan. 23, 2017

Related U.S. Application Data
(60) Provisional application No. 62/286,018, filed on Jan. 22, 2016.

(51) Int. Cl. G06Q 50/26; G06Q 50/00; H04L 29/06; H04L 29/08

(52) U.S. Cl. CPC G06Q 50/265; H04L 63/123; G06Q 50/01; H04L 67/306

(57) ABSTRACT

Systems and methods mitigate bullying and terrorism facilitated through social media and the internet. Systems, methods, and apparatuses detect legitimacy of the sender; message content, timing, authenticity of recipient, authenticity of technology infrastructure, legitimacy of a gift, scheduling, archiving of the message and gift. The present invention may be used to fight vulnerabilities of terrorism activities and bullying.

### CROSS-REFERENCE TO RELATED APPLICATIONS

This application claims priority to U.S. Provisional patent application Ser. No. 62/286,018, filed Jan. 22, 2016, the contents of which are herein incorporated by reference in their entirety.

### FIELD OF THE INVENTION

The present invention relates to internet security.

### BACKGROUND

The evolution of social media has exploded with the start of Facebook, (founded 2004), and further exploded with Twitter (founded 2006), and Snapchat (founded 2011), more recently start up's like SendItLater (founded 2014) and the many blogs that have been created. While these companies have provided tremendous opportunities for individuals to share information about themselves, forming communities for people to help each other with common challenges ranging from families with Alzheimer's to young entrepreneurs. Like many advances in technology, they also come with a dark side.

This is a common dilemma for every scientist and inventor. As is depicted at the MIT cafeteria walker memorial. The painting of the scientist where in his right hand is the good angel and in the left hand is the sinister dog and below him is the militarist and the doctor waiting for his invention.

Sadly, the explosion of the social networks has a dark side they are being used effectively for terrorism (coordinating attacks, recruiting terrorists, and financing), and for bullying (torturing young people and sapping their self-esteem). These uses are now well publicized, however there has been no effective way to mitigate these horrible uses of these wonderful tools. This patent gives that way.

The internet and social networking sites are important weapons in the arsenal of modern terrorists. “What we are seeing now is living proof that social media works” “It's an extraordinary efficient effective way to sell shows, or vacations, or terrorism” Mr. James Comey, FBI Director, Wall Street Journal, Friday Jul. 10, 2015. Further, FBI Says by Damian Paletta (Social Media) “Those fighters, many are recruited through a powerful online media campaign, CBS News' Julianna Goldman reports. “ISIS recruits fighters through powerful online campaign.” http://www.cbsnews.com/. N.p., 29 Aug. 2014. Web. 16 Jul. 2015. http://www.cbsnews.com/news/isis-uses-social-media-to-recruit-western-allies/

“ISIL leverages social media to propagate its message and benefits from thousands of organized supporters globally online, who seek to legitimize its actions while burnishing an image of strength and power,” according to the analysis. “The influence is underscored by the large number of reports stemming from social media postings.” “Why the Islamic State leaves tech companies torn between free speech and security.” https://www.washingtonpost.com. N.p., 16 Jul. 2015. Web. 28 Jul. 2015. https://www.washingtonpost.com/world/national-security/islamic-states-embrace-of-social-media-puts-tech-companies-in-a-bind/2015/07/15/0e5624c4-169c-11e5-89f3-61410da94eb1_story.html

Social media is one of the most used tools in the terrorism arsenal for recruiting new members. Mitigation and reporting of this is crucial in order to maintain safety of citizens when using internet sites. “Nearly 90% of organized terrorism on the internet takes place via social media” “Terrorism and social media.” https://en.wikipedia.org. Wikipedia Foundation, 1 Jun. 2015. Web. 16 Jul. 2015 https://en.wikipedia.org/wiki/Terrorism_and_social media

The United Nations published a document analyzing the use of the internet for terrorism and its global implications. Findings include that the internet is used by terrorists for all stages of terrorism including, Propaganda, Recruitment, Incitement, Radicalization, Financing, Training, Execution, and Cyber Attacks. (“The use of the Internet for terrorist purposes.” http://www.unodc.org/. N.p., September 2012. Web. 28 Jul. 2015. http://www.unodc.org/documents/frontpage/Use_of_Internet_for_Terrorist_Purposes.pdf)

Bullying is another massive problem in the online community. “15% of high school students reported being bullied online” (Center for Disease Control, 2014). “Youth Risk Behavior Surveillance.” http://www.cdc.gov/. N.p., 2015. Web. 16 Jul. 2015. A system needs to be created in order to mitigate bullying from occurring as the repercussions of bullying are gravely serious. “One million children were harassed, threatened or subjected to other forms of cyberbullying on Facebook during the past year”. http://www.internetsafety101.org/cyberbullyingstatistics.htm

Some of the darkest effects of bullying, include suicide due to harassment or pranks on social media. “Suit: Social media prank led to 5th-grader's suicide.” http://www.chicagotribune.com/. Chicago Tribune, 5 Jun. 2015. Web. 16 Jul. 2015.

In 2012, Amanda Todd, a cyber bullying victim left her mother a ‘goodbye’ video revealing why she hung herself. “http://www.mirror.co.uk/. N.p., October 2012. Web. 28 Jul. 2015. http://www.mirror.co.uk/news/world-news/amanda-todd-cyber-bullying-victim-1380108 Research showed that the incidents increased over time, with 23 cases of suicide linked to cyber bullying (56 percent) taking place between 2003 and 2010. LeBlanc said. News, CBC. “Cyberbullying-linked suicides rising, study says.” http://www.cbc.ca/. N.p., n.d. Web. 16 Jul. 2015

Applications of the present inventions to fight vulnerabilities exist within the government and private sector. Compromises have been reported recently; As many as 3,000 Westerners are fighting alongside the Islamic State of Iraq and Syria, or ISIS, and other jihadist groups in Syria and Iraq, “Nearly 90% of organized terrorism on the internet takes place via social media”, “14.8% of high school students reported being bullied online” (Center for Disease Control, 2014)

47% of students have experienced hazing prior to coming to college. 95% of hazing cases go unreported. www.stophazing.org. Hazing is a prevalent issue that keeps growing and spreading to students all around the United States and the world. Between 2010 and 2014, there were over 14 reported hazing deaths which not only effected their parents but also the entire school communities. The number of schools cracking down on hazing has increased, resulting in disbanding teams and groups, including a number of fraternities and sororities. Gangs additionally rely on social media and internet communications. According to the National Gang Center, there was an estimated average of over 30,000 gangs present in the United States in 2012. www.nationalgangcenter.gov. Gang related deaths have increased 25% from 2007 to 2012 and this trend has been continuing. Detroit logs on average 350 gang related deaths per year, while in Chicago, 80% of all homicides are gang related. (http://usconservatives.about.com/od/capitalpunishment/a/Putting-Gun-Death-Statistics-In-Perspective.htm) Gangs are responsible for more deaths each year on US soil than any other source of homicides. See U.S. Pat. No. 7,392,541, U.S. Pat. No. 8,458,789, U.S. Pat. No. 9,032,521, US20150096026, EP1563393, U.S. Pat. No. 8,725,672, U.S. Pat. No. 7,595,815, and U.S. Pat. No. 7,876,351, the contents of each of which are incorporated herein by reference.

### SUMMARY

The present invention is generally related to the mitigation of bullying and terrorism facilitated through social media and the internet. More specifically, this invention relates to a system, method, and apparatus for detecting legitimacy of the sender; message content, timing, authenticity of recipient, authenticity of technology infrastructure, legitimacy of a gift, scheduling, archiving of the message and gift. The present invention may be used to fight vulnerabilities of terrorism activities and bullying.

One embodiment of the present invention is a method for giving situational awareness and alerting on the following conditions: Sender Authentication—provide a mechanism and judgment to determine the ongoing veracity of the “purported” sender with such parameters as: ethnic background, past history, criminal history, ties with terrorism, relationship with recipient, senders location, age, browser history, buying habits, travel habits, servers used, and the meta date that is associated with these variables that quantify the authenticity that quantify these variables.

Similarly, each of the steps in the process of sending a package and the eventual receipt has a method of situational awareness given to it and an alerting mechanism. Collectively through a correlation engine all steps are aggregated with an overall situation awareness mechanism to send a collective alert if warranted.

Certain aspects of the invention may include:

A method for detecting and mitigating bullying and terrorism that would be facilitated through the use of the internet (Invention 1). Giving situational awareness, alerting, mitigation for identifying, preventing bulling and terrorism that is being facilitated on the internet. Specifically, this invention focuses on the following conditions:

In the context of a person (sender), creating an “electronic package” consisting of but not limited to a message (text or multimedia), adding a gift (physical, money (check, Bit Coins, other payment methods) and sending that “package: to a person (recipient) now or in the future via the internet;

The steps involved in detecting and mitigating the use of the internet for the legitimate purpose of creating and sending messages/gifts but misused for terrorism and bullying would be the following:

A system and method for establishing The Legitimacy of Sender and developing a profile—determining the characteristics of the individual of where messages really came from.

A system and method for establishing The Legitimacy of the Message Content, Gift (package)

A system and method for establishing the legitimacy of When the package is to be sent (For example, corresponding with certain suspicious dates e.g. 9/11)

A system and method for establishing the Authenticity of the Recipient

A system and method for developing a Sender/Recipient Profile

A system and method for establishing the Authenticity of the Technology Infrastructure IP Device Authentication—that is being used to transport the “package”—provide a mechanism and judgment to determine the ongoing veracity of the “purported” device with such parameters as unique device ID, history of access, paths taken and other environmental data. The reputation of all the servers through which they passed and in depth analysis of the content structure, including links, in the messages themselves. The internet is comprised of a collection of devices, data, applications and networks all dynamically exchanging information among users. We also present here a mechanism for observing in real time, and putting or accessing those observations into a distributed virtual database for contextual evaluation and analysis of how the internet is being used or potentially subverted for terrorism and bulling—by using real time evaluation of DNS database changes, server logs, performance, device logs, tip data, law enforcement and path resolution.

A system and method for determining Method of Delivery of the package with a Reputation Database—For example, a package being delivered by an unknown delivery system or delivered by a known, reputed carrier service to determine a threshold to issue a phase alert.

A system and method for establishing the Legitimacy Adding a Gift, Type of Gift, Category of Gift, Where is the Gift from—Would the profile of the sender and recipient match where the gift is acquired from A system and method for establishing the Legitimacy of Scheduling the Gift/Package

A system and method for establishing the Legitimacy of Archiving the Gift/Package—Is this the type of “gift” that you would postpone giving or give immediately and the relationship between the people.

A correlation of risk analysis of all adjacent data describing the universe of the above 12 steps. Observability is on all data acquired or access. The networked infrastructure and external sources, implicitly produces that data and hence mechanisms and methods for risk analysis are presented here leading to a dashboard for all assets involved in sending a “package” and receiving it.

A system and method for establishing the Legitimacy of Archiving of the Message

A system and method for establishing the Legitimacy of Sending the Message/Gift/Package

A system and method for correlating all of the above into an alert to mitigate bullying, terrorism, hazing, and gang related activities.

A system and method for correlating all of the above information to create a hint for each group of data points received from each phase to determine a threshold to issue a hint alert.

A system and method for correlating all of the hints from a single phase and their weighting to determine a threshold to issue a phase alert.

A system and method for correlating all of the phase alerts from the overall process flow to determine a threshold to issue a system alert.

A system and method for establishing the Historical Patterns of Bullying and Terrorism using Social Media. This will be accomplished by establishing a matrix of all users, senders and recipients, in placing a value of patterns and relationships between the two. Continually observe historical patterns and feed that back into the 18 steps above to create a heuristic feedback mechanism in modifying all steps above. For instance, we find out sometime in the future that terrorists are using a particular bank to launder the money through, we would feed this historical information into step 15 to continually improve the accuracy of the phase alerts.

A system and method for correlating the system alerts with their weighting and importance to determine the level of authority that should be notified, if no or an inadequate response is received, alert will pass along the escalation engine and will be sent to the next higher level of authority.

The 12 phases in total may be used for detecting terrorism and bullying in applications where any type of communication, globally or locally, between individuals and among social networking through the internet or any other type of network (Ex. Facebook, Twitter). Or in applications where we are trying to verify migrants/refugee as potential dangerous elements. However, each phase can be used independently or in combination with just a few of the other phases to give indications of terrorism and bullying and create the necessary alerts to mitigate the consequences of terrorism and bullying.

### BRIEF DESCRIPTION OF THE DRAWINGS

FIG. 1 depicts the overall process flow according to certain embodiments of the invention.

FIG. 2 depicts the legitimacy of sender phase according to certain embodiments of the invention.

FIG. 3 depicts the legitimacy of message content phase according to certain embodiments of the invention.

FIG. 4 depicts the when to send a message phase according to certain embodiments of the invention.

FIG. 5 depicts the authenticity of the recipient phase according to certain embodiments of the invention.

FIG. 6 depicts the developing a recipient profile phase according to certain embodiments of the invention.

FIG. 7 depicts the establishing the authenticity of the technology infrastructure phase according to certain embodiments of the invention.

FIG. 8 depicts the determining method of delivery phase according to certain embodiments of the invention.

FIG. 9 depicts the adding a gift phase according to certain embodiments of the invention.

FIG. 10 depicts the scheduling of the gift phase according to certain embodiments of the invention.

FIG. 11 depicts the archiving the gift phase according to certain embodiments of the invention.

FIG. 12 depicts the archiving the message phase according to certain embodiments of the invention.

FIG. 13 depicts the sending the message/gift phase according to certain embodiments of the invention.

FIG. 14 shows an example of an automatic, customizable, forensic analysis of alerted situation.

FIG. 15 shows an example of a three-tier implementation architecture for analysis/correlation, alert engine, and authentication and reputation database components.

### DETAILED DESCRIPTION OF THE INVENTION

The present invention provides a system, a method, and an apparatus for situational awareness of the legitimacy of senders, recipients, infrastructure which comprise the internet, which is being used to send messages and gifts into the future.

### Systems Architecture

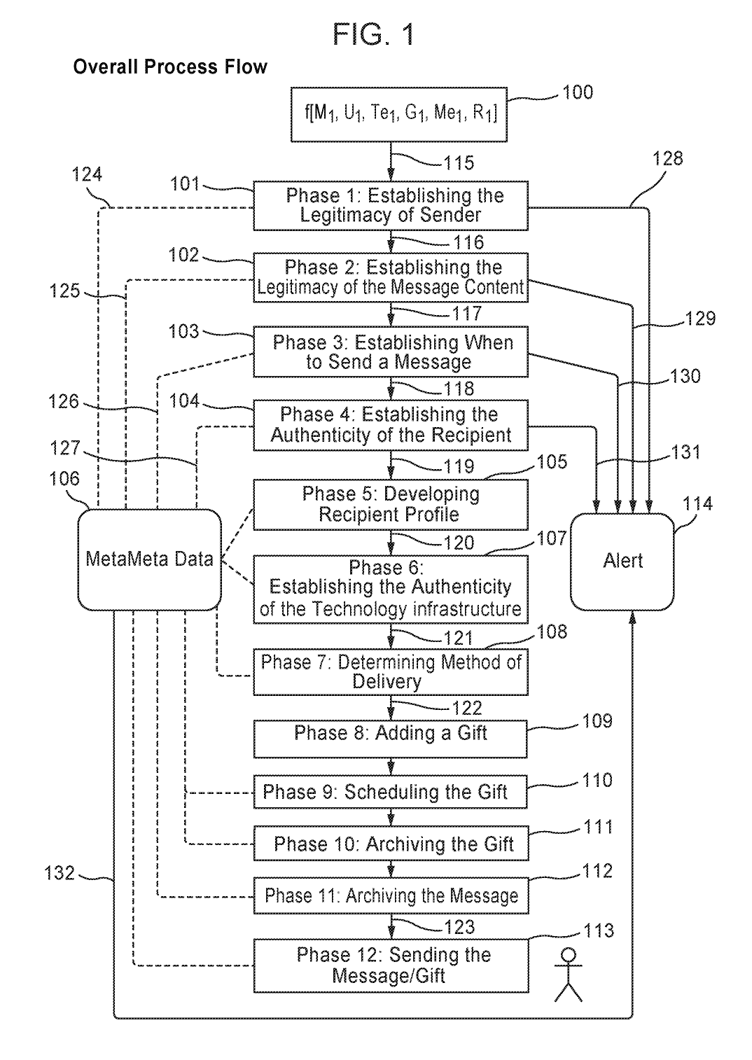

One embodiment of the present invention is a system, a method, and an apparatus for data surveillance, vulnerabilities detection and alerting in an ecommerce site. FIG. 1 shows an example of a system architecture of one embodiment of the present invention related to an ecommerce site. The Overall Process Flow begins by taking an input (100) and running it though the various phases needed to complete a secure, legitimate, mitigated, authenticated, and trusted, purchase and mode of communication in such site (116,117,118, 119, 120, 121, 122, 109, 110, 111, 112, 113). The alert engine (114) is triggered if the System Alert is high enough. An Escalated Alert is created and sent to the appropriate authorities. The Escalated Alert has dynamic and customizable rules activated by all data sources. This system works by gathering Data, Meta Data, and Meta-Meta Data within each of the phases to legitimize, secures, authorizes, and validates each of the steps within the system. The process flow links the different phases needed in it and check each steps against terrorism and bullying. The system makes sure that each phase is valid before moving on to the next one.

### Example Phases

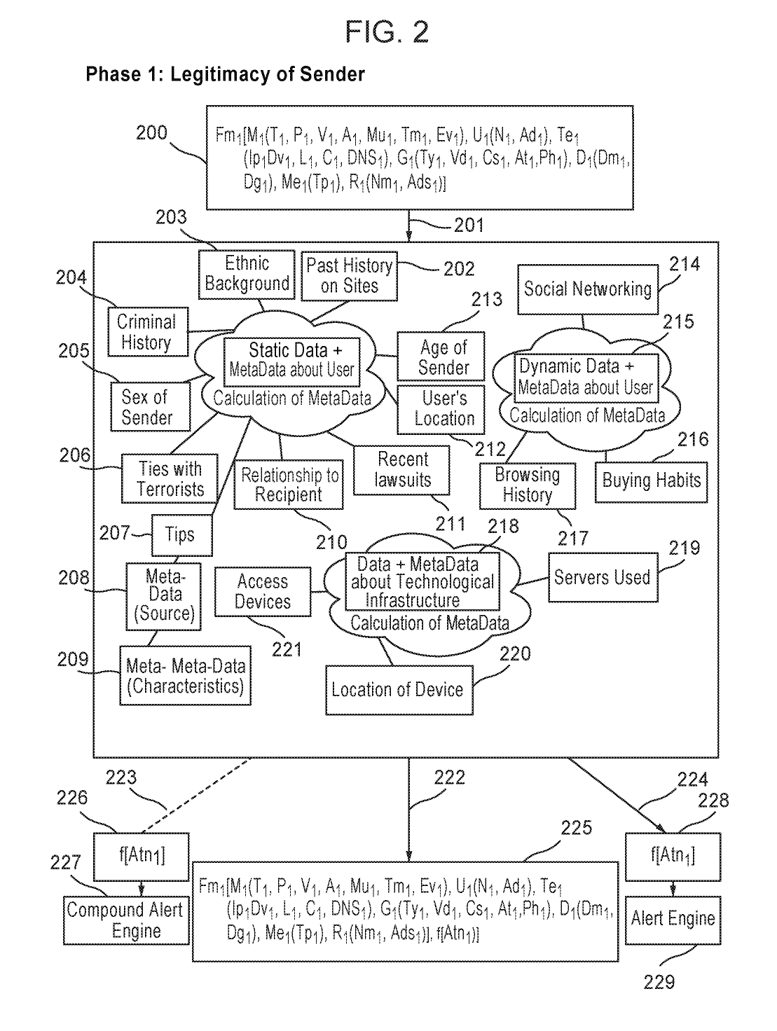

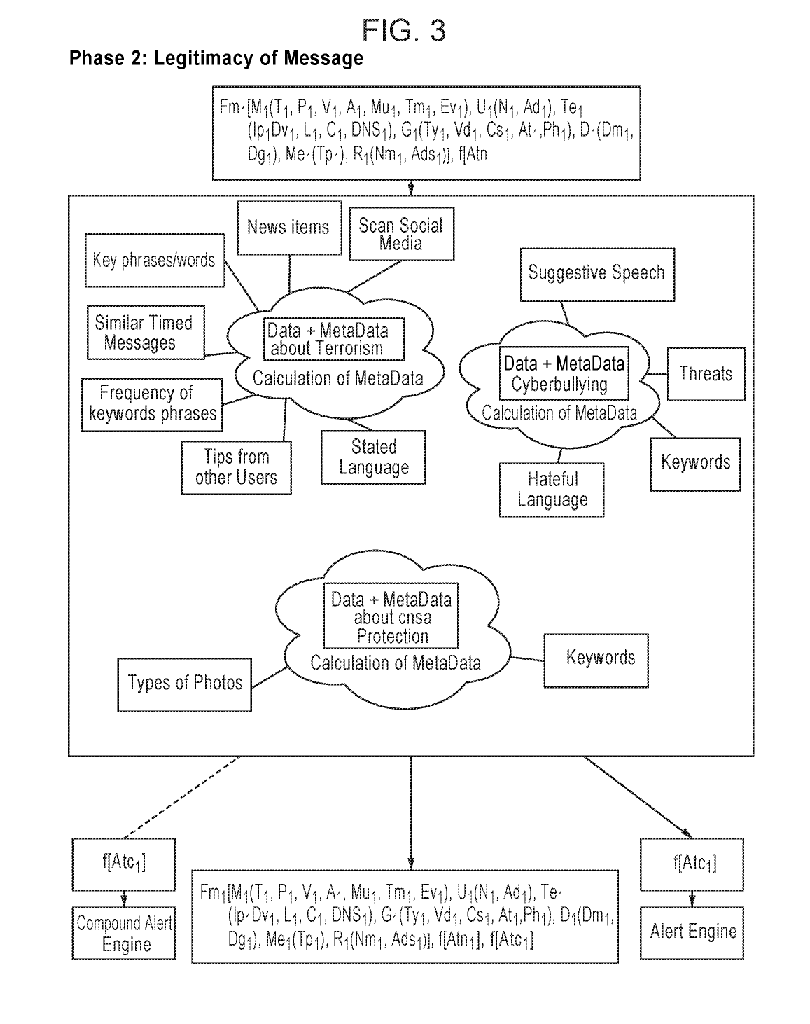

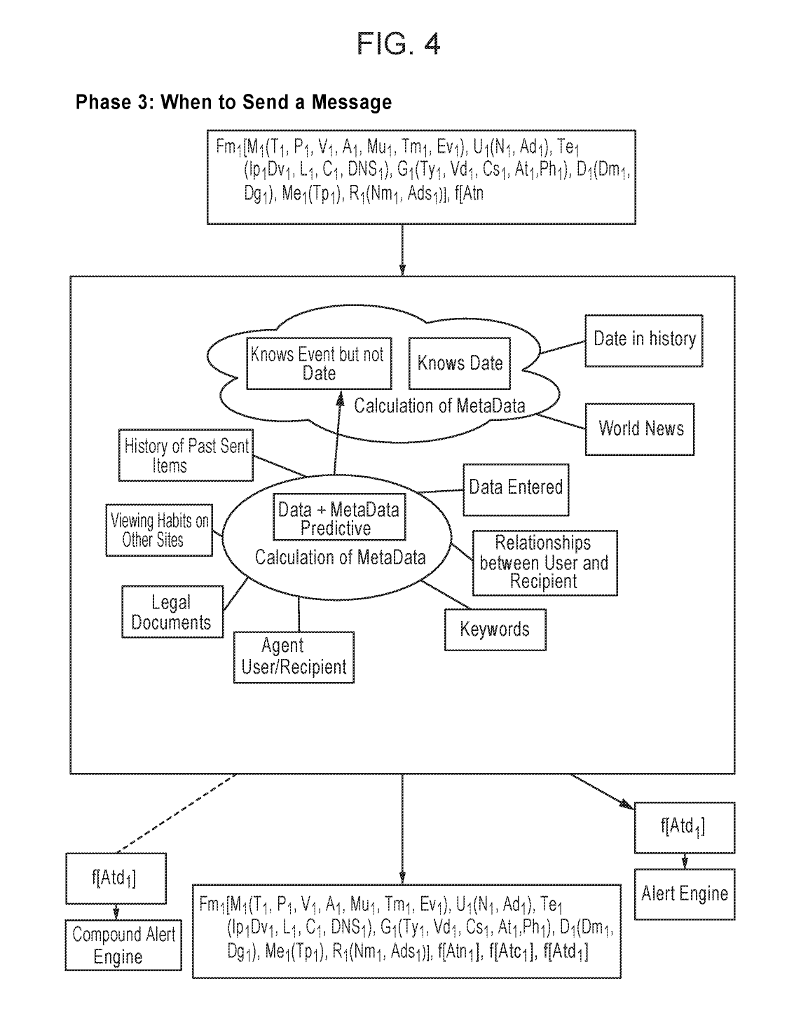

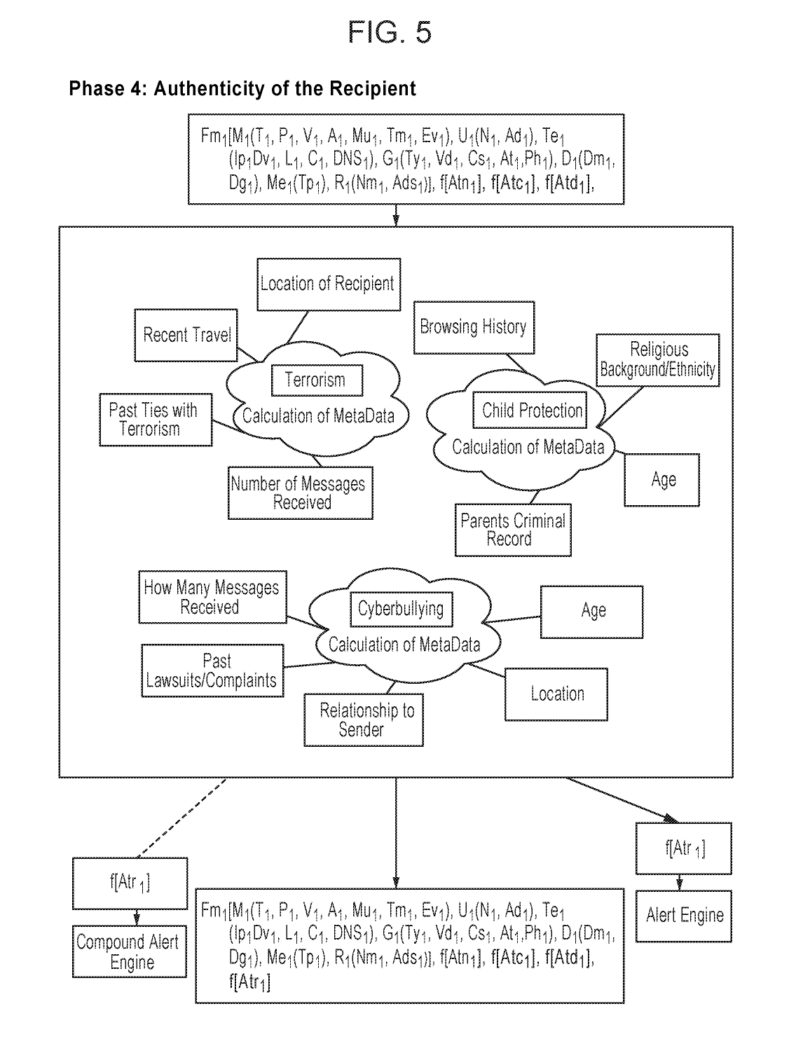

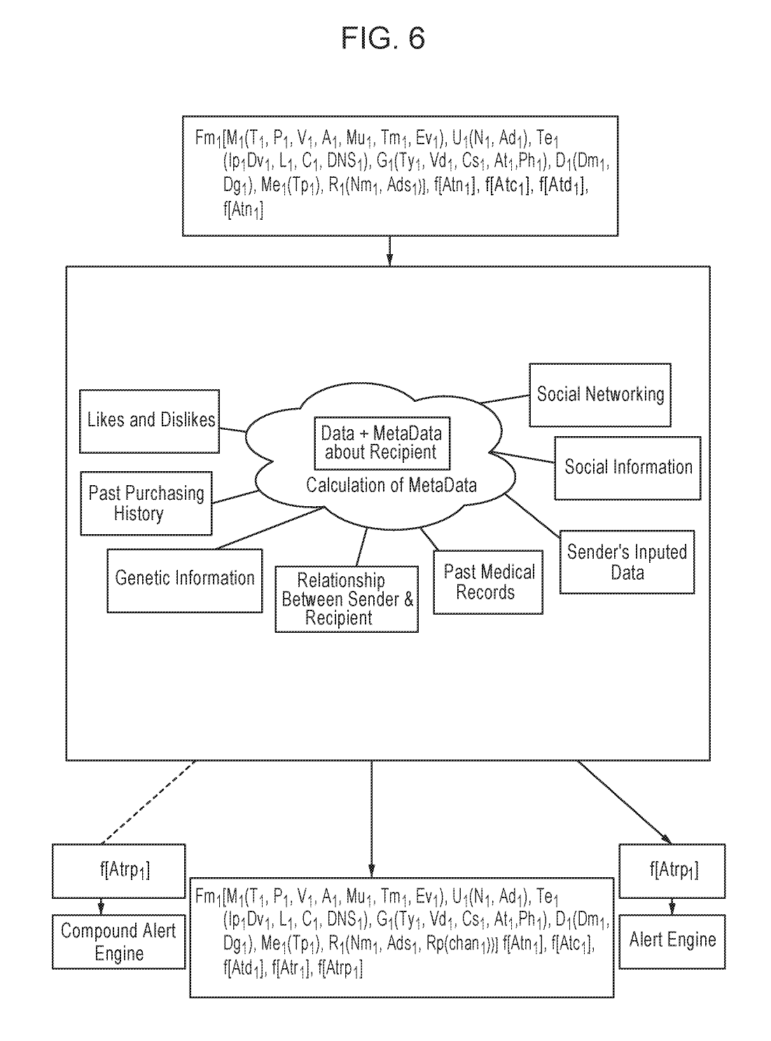

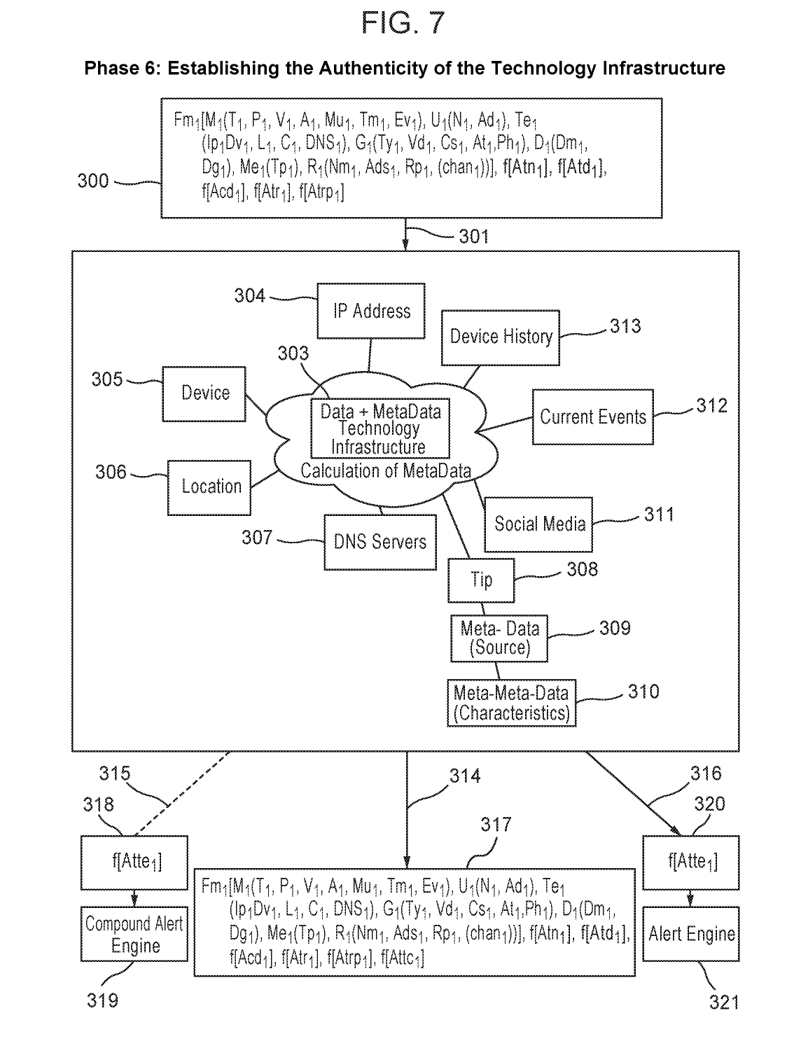

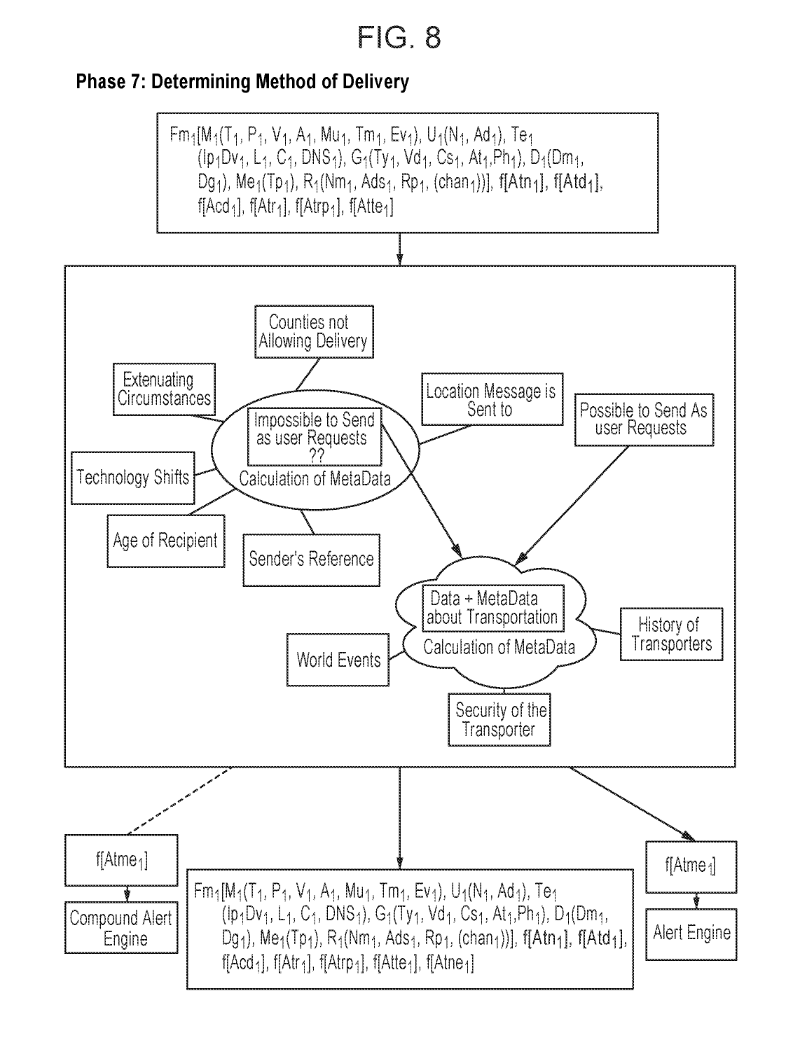

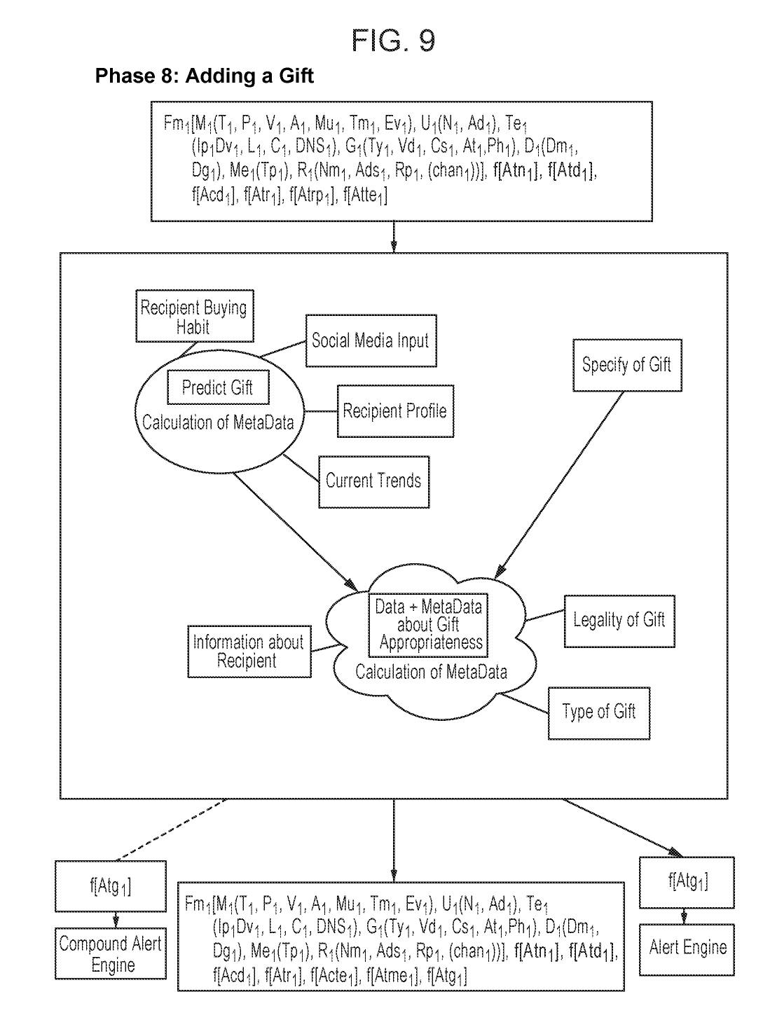

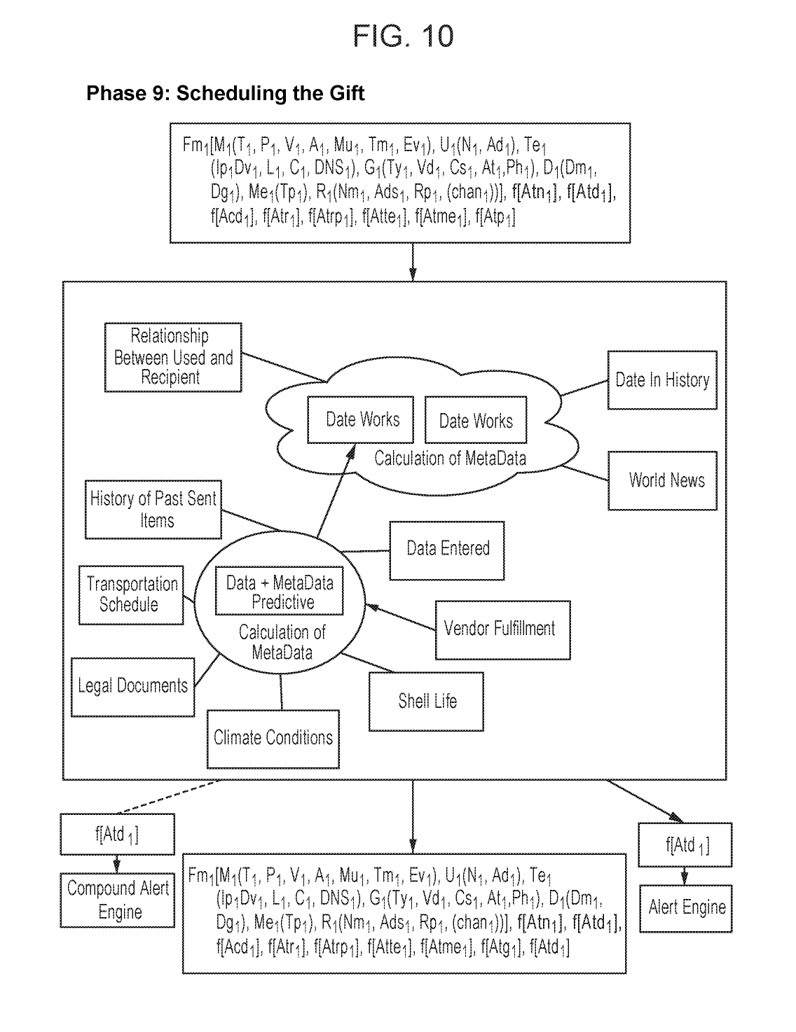

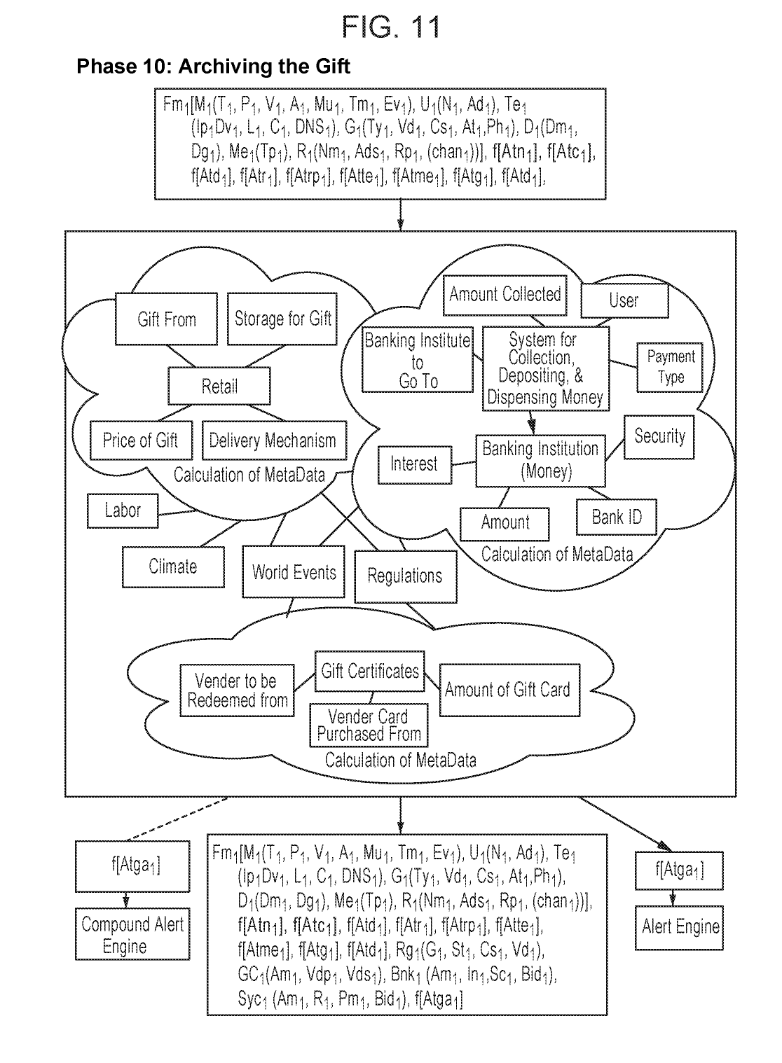

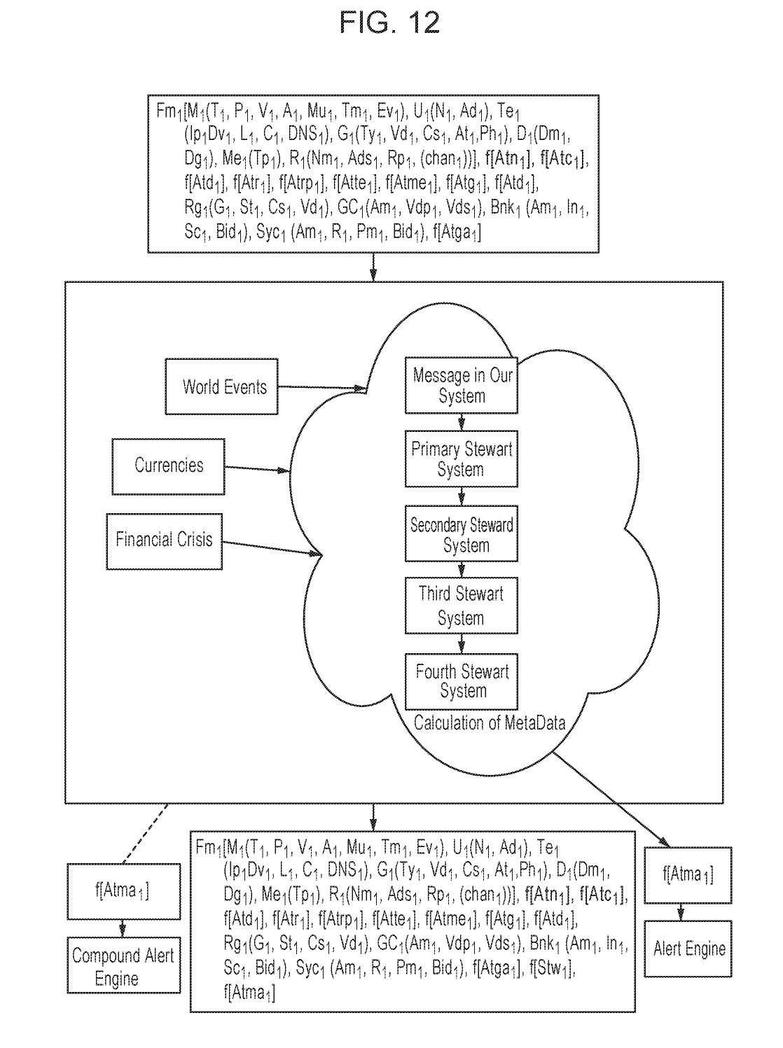

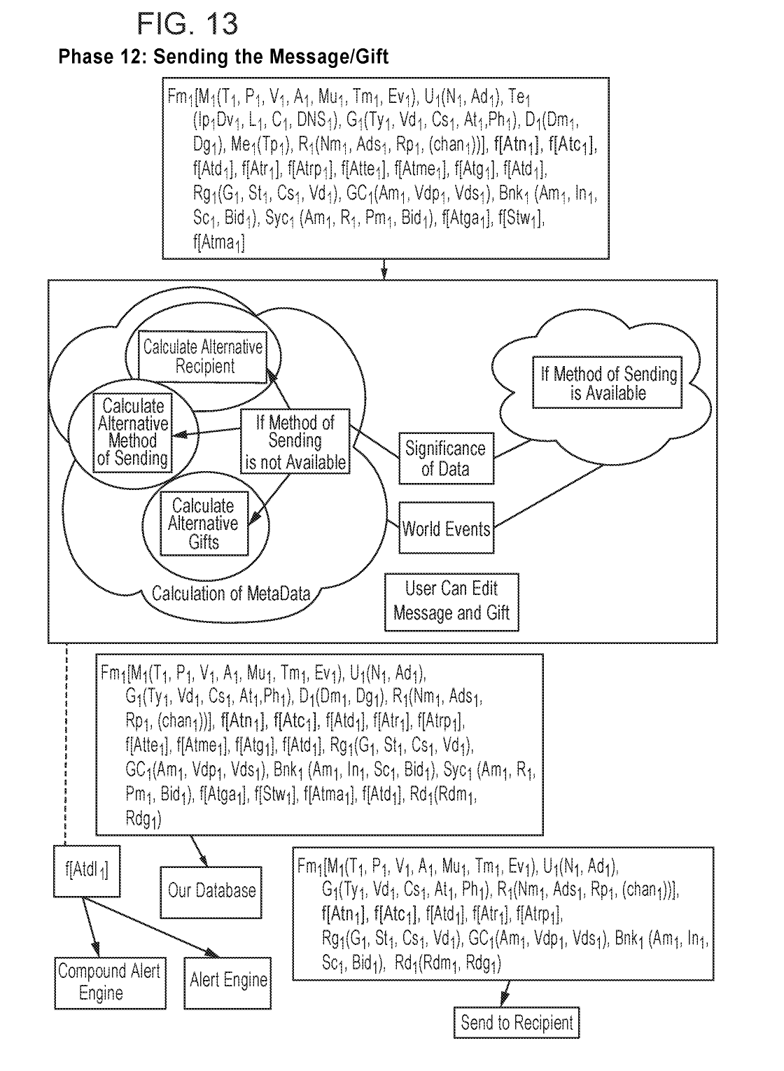

FIGS. 2 through 13 depict each of the phases in the example of the Overall Process Flow shown in FIG. 1. The phases are based on the use of an ecommerce site which allows its users to send a message and attach a gift. This message and gift can be achieved and scheduled for delivery on a future date. The Overall Process Flow checks in each step to make sure the whole message is secure. These phases include:
Legitimacy of the Sender (FIG. 2)
   This phase in the example Overall Process Flow establishes the legitimacy of the sender which allows the system to understand whether the sender is correctly representing themselves. Data, Meta Data, and Meta-Meta Data is gathered to analyze and fulfilling the purpose of this Phase.
Legitimacy of the Message Content (FIG. 3)
   This phase in the example Overall Process Flow establishes the legitimacy of the message the sender is trying to send to a recipient. It also allows the system to understand whether the message being sent has any threat attached to it to determine if its terrorism, bullying or none, which would clear it to being sent. Data, Meta Data, and Meta-Meta Data is gathered to analyze and fulfilling the purpose of this Phase.
When to Send the Message (FIG. 4)
   This phase in the example Overall Process Flow establishes the possible malicious intent of a message based on the date created or scheduled for delivery. Data, Meta Data, and Meta-Meta Data is gathered to analyze and fulfilling the purpose of this Phase.
Authenticity of the Recipient (FIG. 5)
   This phase in the example Overall Process Flow establishes the authenticity of the recipient. Data, Meta Data, and Meta-Meta Data is gathered to analyze and fulfilling the purpose of this Phase.
Developing a Recipient Profile (FIG. 6)
   This phase in the example Overall Process Flow generated a profile about the recipient based on information gathered on them. Data, Meta Data, and Meta-Meta Data is gathered to analyze and fulfilling the purpose of this Phase.
Establishing the Authenticity of the Technology Infrastructure (FIG. 7)
   This phase in the example Overall Process Flow establishes the authenticity of the technology infrastructure used by both the sender and recipient. This includes infrastructure used through the whole ordering, scheduling, sending, and receiving process. Data, Meta Data, and Meta-Meta Data is gathered to analyze and fulfilling the purpose of this Phase.
Determining Method of Delivery (FIG. 8)
   This phase in the example Overall Process Flow determines the level of threat within the method of delivery chosen by the sender. Data, Meta Data, and Meta-Meta Data is gathered to analyze and fulfilling the purpose of this Phase.
Adding a Gift (FIG. 9)
   This phase in the example Overall Process Flow legitimizes the action performed by the sender of adding a gift for the recipient. This makes sure that the gift is appropriate and mitigated before it is sent. Data, Meta Data, and Meta-Meta Data is gathered to analyze and fulfilling the purpose of this Phase.
Scheduling a Gift (FIG. 10)
   This phase in the example Overall Process Flow legitimizes the scheduling of a gift by the sender for the recipient. It makes sure that the scheduled date of the gift is mitigated before it is achieved and sent. Data, Meta Data, and Meta-Meta Data is gathered to analyze and fulfilling the purpose of this Phase.
Archiving a Gift (FIG. 11)
   This phase in the example Overall Process establishes the authenticity of the gift in order to archive the order. Data, Meta Data, and Meta-Meta Data is gathered to analyze and fulfilling the purpose of this Phase.
Archiving the Message (FIG. 12)
   This phase in the example Overall Process of securely authenticating and archiving the message sent by the sender to the recipient on a future date. Data, Meta Data, and Meta-Meta Data is gathered to analyze and fulfilling the purpose of this Phase.
Sending the Message/Gift (FIG. 13)
   This phase in the example Overall Process of securely authenticating and sending the message sent by the sender to the recipient on a future date. Data, Meta Data, and Meta-Meta Data is gathered to analyze and fulfilling the purpose of this Phase.
Establishing the Historical Patterns of Bullying and Terrorism using Social Media
   This will be accomplished by establishing a matrix of all users, senders and recipients, in placing a value of patterns and relationships between the two. Continually observe historical patterns and feed that back into the 13 steps above to create a heuristic feedback mechanism in modifying all 13 steps above. For instance, we find out sometime in the future that terrorists are using a particular bank to launder the money through, we would feed this historical information into step 13.

The architecture depicted in FIG. 1 can be generally applied to the most complicated sending of packages, however we may eliminate steps for specific uses of this architecture to limit terrorism. For example, detecting terrorism suspects entering a country via asylum would not involve the steps regarding gifting and all steps would be customized.

Each phase involves not only gathering data associated with that step but also inside each phase meta data is gathered: inside each meta data, meta-meta data is gathered. Each of these data points are analyzed and weighted to determine whether or not this is securely mitigated from terrorism and bullying process, and may result in triggering an alert.

Often the alerts from each step do not have a high enough consequence but collectively they would.

### Threat Message Creating

Once all the data from the overall process is gathered, the system within the architecture identifies whether or not to contact an authority figure (dependent on created threat level). It also gathers and sends the appropriate information that this authority will find useful when investigating and acting on a threat. Further, if the authority figure does not respond, there is a method for escalating that alert.

### Profile Data Gathering

Finally, the system within the architecture will create threat profiles. These will be made in order to secure not only present use of the application where the architecture is installed, but also in the future, adding heuristically to the knowledge base of the entire system. This creates threat patterns which can be analyzed and reviewed by the architecture to allow for continued enhancement in security and data analytics. This part of the architecture will keep track of sender and recipient threat pattern and will identify suspicious or malicious activity and trends.

The following describes each of the figures which depict examples of the embodiment of the present invention and possible data that would be used in the mathematical calculations to detect bullying, terrorism and in the process of sending messages and gifts into the future.

FIG. 1—depicts the overall process of sending a “package” and the eventual receipt of that package by a recipient. The variables that are calculated at each step and passed along are as follows:

### Variable Description of FIG. 1

Fmᵢ[Mᵢ(Tᵢ, Pᵢ, Vᵢ, Aᵢ, Muᵢ, Evᵢ), Uᵢ(Nᵢ, Adᵢ),Teᵢ(Ipᵢ,Dvᵢ, Lᵢ, Cᵢ, DNSᵢ), Gᵢ(Tyᵢ,Vdᵢ,Csᵢ, Atᵢ, Phᵢ), Dᵢ(Dmᵢ, Dgᵢ), Meᵢ(Tpᵢ), Rᵢ(Nmᵢ, Adsᵢ)]
   Fm=Function of all variables
M=Message Function
   T=Text
   P=Pictures
   V=Video
   A=Audio
   Mu=Music
   Tm=Tips
   Ev=Environment
U=User/Sender
   N=Name
   Ad=Address
Te=Infrastructure
   Ip=Ip Address
   Dv=Device
   L=Location
   C=Current Events
   DNS=Domain Name Services
G=Gift function
   Ty=Type
   Vd=Vendor
   Cs=Specific Gift
   At=Amount
   Ph=Information about Recipients
D=Delivery function
   Dm=Message on our system
   Dg=Gift on System
Me=Meta Data about Transportation
   Tp=Transportation
R=Recipient Function
   F[atm]=Alert from Message
   F[atc]=Alert from Current Events
   F[atd]=Alert from Delivery Function
   F[atr]=Alert Recipient Function
   F[atrp], Alert from Recipient Profile
   F[atte]=Alert of Infrastructure
   F[Atme], Alert on Meta-Data about Transportation
   F[atg], Alert on Gift
   F[atd]=Alert on Date of Scheduled Gift
   Td=Date of Scheduled Gift
   Rg=Chosen Recipient Gift
   Gc=Gift Certificates
      Am=Amount on Gift Certificate
      Vdp=Vendor Card Purchase
      Vds=Vendor to be Redeemed From
   Bnk=Bank Account
      Am=Amount Collected
      In=Interest
      Sc=Security
      Bid=Bank ID
   Syc=System for Collecting Depositing and Disbursing Money
      Am=Amount Collected
      R=Recipient Function
      Pm=Payment Type
   F[Atga]=Alert of Gift Achiving
   F[stw]=Alert from Steward Threat System
   F[Atma]=Alert when Archiving the Message

Each on the following figures depict an example of an instance of calculating the situational awareness and alerting.

FIG. 2—illustrates a systems architecture for establishing the legitimacy of the sender including fundamental data on the person: criminal history, sex, ethnic background, ties with terrorist, relationship with the recipient, recent lawsuits, IP address; on the hardware: access devices, service used, location of devices, past history of site; on the environment; buying habits, browsing history and social network history. Using the meta-data, and meta-data about the meta-data as well as the fundamental data a calculation is made as to rating the authenticity of this architecture. That result is sent to an alert engine and if it is above a certain threshold then an alert is sent. The result is also sent to a compound alert engine that takes into account all the resulting functions for each of the twelve steps and if that results in a situation above a certain threshold then an alert is issued from the compound engine. The input to this legitimacy of sender calculation is depicted as a function.

### Input—Phase 1

Fmᵢ[Mᵢ(Tᵢ,Pᵢ,Vᵢ, Aᵢ, Muᵢ, Tmᵢ Evᵢ),Uᵢ(Nᵢ, Adᵢ),Teᵢ(Ipᵢ, Dvᵢ, Lᵢ, Cᵢ, DNSᵢ), Gᵢ(Tyᵢ,Vdᵢ,Csᵢ, Atᵢ, Phᵢ), Dᵢ(Dmᵢ, Dgᵢ),Meᵢ(Tpᵢ),Rᵢ(Nmᵢ, Adsᵢ)]

The output to this legitimacy of sender calculation is depicted as a function.

### Output—Phase 1

Fmᵢ[Mᵢ(Tᵢ, Pᵢ, Vᵢ, Aᵢ, Muᵢ,Tmᵢ, Evᵢ), Uᵢ(Nᵢ, Adᵢ,Teᵢ(Ipᵢ, Dvᵢ, Lᵢ, Cᵢ, DNSᵢ),Gᵢ(Tyᵢ,Vdᵢ,Csᵢ, Atᵢ, Phᵢ), Dᵢ(Dmᵢ, Dgᵢ), Meᵢ(Tpᵢ), Rᵢ(Nmᵢ, Acsᵢ)], f[Atnᵢ]

*Red—has been determined and on to the next phase.

FIG. 3—illustrates a systems architecture for establishing the legitimacy of message content including fundamental data on the message evaluated for terrorism: key phrases and words, news items, social media, stilted language, tips from other users, frequency of key words and phrases, similarly timed messages. On the message evaluated for cyberbullying: threats, keywords, hateful language, and suggestive speech. On the message for child protection: types of photos and keywords. Using the meta-data, and meta-data about the meta-data as well as the fundamental data, a calculation is made as to rating the authenticity of this architecture. That result is sent to an alert engine and if it is above a certain threshold then an alert is sent. The result is also sent to a compound alert engine that takes into account all the resulting functions for each of the twelve steps and if that results in a situation above a certain threshold then an alert is issued from the compound engine.

The input to this legitimacy of sender calculation is depicted as a function.

### Input—Phase 2

Fmᵢ[Mᵢ(Tᵢ, Pᵢ, Vᵢ, Aᵢ, Muᵢ,Tmᵢ, Evᵢ), Uᵢ(Nᵢ, Adᵢ,Teᵢ(Ipᵢ, Dvᵢ, Lᵢ, Cᵢ, DNSᵢ), Gᵢ (Tyᵢ,Vdᵢ,Csᵢ, Atᵢ, Phᵢ), Dᵢ(Dmᵢ, Dgᵢ), Meᵢ(Tpᵢ), Rᵢ(Nmᵢ, Acsᵢ)], f[Atnᵢ]

The output to this legitimacy of sender calculation is depicted as a function.

### Output—Phase 2

Fmᵢ[Mᵢ(Tᵢ, Pᵢ, Vᵢ, Aᵢ, Muᵢ,Tmᵢ, Evᵢ), Uᵢ(Nᵢ, Adᵢ), Teᵢ(Ipᵢ, Dvᵢ, Lᵢ, Cᵢ, DNSᵢ), Gᵢ (Tyᵢ,Vdᵢ, Csᵢ, Atᵢ, Phᵢ), Dᵢ(Dmᵢ, Dgᵢ), Meᵢ(Tpᵢ), Rᵢ(Nmᵢ, Adsᵢ)], f[Atnᵢ], f[Atcᵢ]

*Red—has been determined and on to the next phase

FIG. 4—illustrates a systems architecture for establishing the legitimacy of when the message will be sent including fundamental data on the message evaluated for terrorism: history of past sent items, types of data entered, relationship between sender and recipient, ancestry, age of sender/recipient, legal documents, viewing habits on other sites, history of past sent items. A calculation is made from that data and meta-data which is fed into an engine that has fundamental data: date history, world news. That result is sent to an alert engine and if it is above a certain threshold then an alert is sent. The result is also sent to a compound alert engine that takes into account all the resulting functions for each of the twelve steps and if that results in a situation above a certain threshold then an alert is issued from the compound engine. The input to this legitimacy of sender calculation is depicted as a function.

The input to this legitimacy of when the message will be sent is depicted as a function.

### Input—Phase 3

Fmᵢ[Mᵢ(Tᵢ, Pᵢ, Vᵢ, Aᵢ, Muᵢ,Tmᵢ, Evᵢ), Uᵢ(Nᵢ, Adᵢ),T eᵢ(Ipᵢ, Dvᵢ, Lᵢ, Cᵢ, DNSᵢ), Gᵢ (Tyᵢ,Vdᵢ, Csᵢ, Atᵢ, Phᵢ), Dᵢ(Dmᵢ, Dgᵢ), Meᵢ(Tpᵢ), Rᵢ(Nmᵢ, Adsᵢ)], f[Atnᵢ], f[Atcᵢ]

The output to this legitimacy of when the message will be sent is depicted as a function.

### Output—Phase 3

Fmᵢ[Mᵢ(Tᵢ, Pᵢ, Vᵢ, Aᵢ, Muᵢ,Tmᵢ, Evᵢ), Uᵢ(Nᵢ, Adᵢ),Teᵢ(Ipᵢ, Dvᵢ, Lᵢ, Cᵢ, DNSᵢ), Gᵢ(Tyᵢ,Vdᵢ, Csᵢ, Atᵢ, Phᵢ), Dᵢ(Dmᵢ, Dgᵢ),Meᵢ(Tpᵢ), Rᵢ(Nmᵢ, Adsᵢ)], f[Atnᵢ], f[Atcᵢ], f[Atdᵢ]

*Red—has been determined and on to the next phase

FIG. 5—illustrates a systems architecture for establishing the authenticity of the recipient including fundamental data on the message evaluated for terrorism: location of the recipient, number of messages received, past ties with terrorists, recent travel. On the message evaluated for cyberbullying: Age, location, relationship to sender, past lawsuits/complaints, how many messages received. On the message for child protection: browsing history, religious background ethnicity, age and parent's criminal record. Using the meta-data, and meta-data about the meta-data as well as the fundamental data, a calculation is made as to rating the authenticity of this architecture. That result is sent to an alert engine and if it is above a certain threshold then an alert is sent. The result is also sent to a compound alert engine that takes into account all the resulting functions for each of the twelve steps and if that results in a situation above a certain threshold then an alert is issued from the compound engine.

The input to this authenticity of the recipient calculation is depicted as a function.

### Input—Phase 4

Fmᵢ[Mᵢ(Tᵢ, Pᵢ, Vᵢ, Aᵢ, Muᵢ,Tmᵢ,Evᵢ),Uᵢ(Nᵢ, Adᵢ),Teᵢ(Ipᵢ, Dvᵢ, Lᵢ, Cᵢ, DNSᵢ),Gᵢ(Tyᵢ,Vdᵢ,Csᵢ, Atᵢ, Phᵢ), Dᵢ(Dmᵢ, Dgᵢ), Meᵢ(Tpᵢ), Rᵢ(Nmᵢ, Adsᵢ)], f[Atnᵢ], f[Atcᵢ], f[Atdᵢ]

The output to this authenticity of the recipient calculation is depicted as a function.

### Output—Phase 4

Fmᵢ[Mᵢ(Tᵢ, Pᵢ, Vᵢ, Aᵢ, Muᵢ,Tmᵢ,Evᵢ),Uᵢ(Nᵢ, Adᵢ),Teᵢ(Ipᵢ, Dvᵢ, Lᵢ, Cᵢ, DNSᵢ), Gᵢ(Tyᵢ,Vdᵢ, Csᵢ, Atᵢ, Phᵢ), Dᵢ(Dmᵢ, Dgᵢ), Meᵢ(Tpᵢ), Rᵢ(Nmᵢ, Adsᵢ)], f[Atnᵢ], f[Atdᵢ], f[Atrᵢ]

*Red—has been determined and on to the next phase

FIG. 6—illustrates a systems architecture for establishing the legitimacy of the recipient's profile including fundamental data on the message evaluated for terrorism, cyberbullying and child protection: social media, social information, past medical records, relationship between sender and recipient, genetic information, past purchasing history and likes and dislikes. A calculation is made from that data and meta-data which is fed into an engine that has fundamental data: date history, world news. That result is sent to an alert engine and if it is above a certain threshold then an alert is sent. The result is also sent to a compound alert engine that takes into account all the resulting functions for each of the twelve steps and if that results in a situation above a certain threshold then an alert is issued from the compound engine.

The input to this legitimacy of the recipients profile calculation is depicted as a function.

### Input—Phase 4

Fmᵢ[Mᵢ(Tᵢ, Pᵢ, Vᵢ, Aᵢ, Muᵢ,Tmᵢ, Evᵢ),Uᵢ(Nᵢ, Adᵢ),Teᵢ(Ipᵢ, Dvᵢ, Lᵢ, Cᵢ, DNSᵢ), Gᵢ(Tyᵢ, Vdᵢ, Csᵢ, Atᵢ, Phᵢ), Dᵢ(Dmᵢ, Dgᵢ), Meᵢ(Tpᵢ), Rᵢ(Nmᵢ, Adsᵢ)], f[Atnᵢ], f[Atcᵢ], f[Atdᵢ], f[Atrᵢ]

The output to this legitimacy of the recipient's profile is depicted as a function.

### Output—Phase 4

Fmᵢ[Mᵢ(Tᵢ, Pᵢ, Vᵢ, Aᵢ, Muᵢ,Tmᵢ, Evᵢ),Uᵢ(Nᵢ, Adᵢ),Teᵢ(Ipᵢ, Dvᵢ, Lᵢ, Cᵢ, DNSᵢ), Gᵢ(Tyᵢ, Vdᵢ, Csᵢ, Atᵢ, Phᵢ), Dᵢ(Dmᵢ, Dgᵢ), Meᵢ(Tpᵢ), Rᵢ(Nmᵢ, Adsᵢ, Rpᵢ(Charᵢ))], f[Atnᵢ], f[Atcᵢ], f[Atdᵢ], f[Atrᵢ], f[Atrpᵢ]

*Red—has been determined and on to the next phase

FIG. 7—illustrates a systems architecture for establishing the authenticity of the technology infrastructure including fundamental data for evaluation of terrorism, cyberbullying and child protection: device history, current events, social media, DNS service, location, devices, IP addresses, all these basic data items are supplemented with meta-data on each of the fundamental data. Using the meta-data and meta-data about the meta-data as well as the fundamental data a calculation is made as to rating the authenticity of this architecture. That result is sent to an alert engine and if it is above a certain threshold then an alert is sent. The result is also sent to a compound alert engine that takes into account all the resulting functions for each of the twelve steps and if that results in a situation above a certain threshold then an alert is issued from the compound engine.

The input to this legitimacy of the technology infrastructure is depicted as a function.

### Input—Phase 5

Fmᵢ[Mᵢ(Tᵢ, Pᵢ, Vᵢ, Aᵢ, Muᵢ,Tmᵢ, Evᵢ),Uᵢ(Nᵢ, Adᵢ),Teᵢ(Ipᵢ, Dvᵢ, Lᵢ, Cᵢ, DNSᵢ), Gᵢ(Tyᵢ, Vdᵢ, Csᵢ, Atᵢ, Phᵢ), Dᵢ(Dmᵢ, Dgᵢ), Meᵢ(Tpᵢ), Rᵢ(Nmᵢ, Adsᵢ, Rpᵢ(Charᵢ))], f[Atnᵢ], f[Atcᵢ], f[Atdᵢ], f[Atrᵢ], f[Atrpᵢ]

The output to this legitimacy of the technology infrastructure is depicted as a function.

### Output—Phase 5

Fmᵢ[Mᵢ(Tᵢ, Pᵢ, Vᵢ, Aᵢ, Muᵢ,Tmᵢ, Evᵢ),Uᵢ(Nᵢ, Adᵢ),Teᵢ(Ipᵢ, Dvᵢ, Lᵢ, Cᵢ, DNSᵢ), Gᵢ(Tyᵢ, Vdᵢ, Csᵢ, Atᵢ, Phᵢ), Dᵢ(Dmᵢ,Dgᵢ), Meᵢ(Tpᵢ), Rᵢ(Nmᵢ, Adsᵢ, Rpᵢ(Charᵢ))], f[Atnᵢ], f[Atcᵢ], f[Atdᵢ], f[Atrᵢ], f[Atrpᵢ], f[Atteᵢ]

*Red—has been determined and on to the next phase

FIG. 8—illustrates a systems architecture for establishing the legitimacy of the method of delivery including fundamental data on the message and/or gift evaluated for terrorism, cyberbullying and child protection: technology shifts, age of recipient, sender's preference, location where the message is sent to, countries not allowing delivery, extenuating circumstances. A calculation is made from that data and meta-data which is fed into an engine that has fundamental data: world events, history of transporters, security of transporters. That result is sent to an alert engine and if it is above a certain threshold then an alert is sent. The result is also sent to a compound alert engine that takes into account all the resulting functions for each of the twelve steps and if that results in a situation above a certain threshold then an alert is issued from the compound engine.

The input to this legitimacy of the method of delivery calculation is depicted as a function.

### Input—Phase 6

Fmᵢ[Mᵢ(Tᵢ, Pᵢ, Vᵢ, Aᵢ, Muᵢ,Tmᵢ,Evᵢ),Uᵢ(Nᵢ, Adᵢ),Teᵢ(Ipᵢ, Dvᵢ, Lᵢ, Cᵢ, DNSᵢ), Gᵢ(Tyᵢ, Vdᵢ, Csᵢ, Atᵢ, Phᵢ), Dᵢ(Dmᵢ, Dgᵢ), Meᵢ(Tpᵢ), Rᵢ(Nmᵢ, Adsᵢ, Rpᵢ(Charᵢ))], f[Atnᵢ], f[Atcᵢ], f[Atdᵢ], f[Atrᵢ], f[Atrpᵢ], f[Atteᵢ],

The output to this legitimacy of the method of delivery is depicted as a function.

### Output—Phase 6

Fmᵢ[Mᵢ(Tᵢ, Pᵢ, Vᵢ, Aᵢ, Muᵢ,Tmᵢ,Evᵢ),Uᵢ(Nᵢ, Adᵢ),Teᵢ(Ipᵢ, Dvᵢ, Lᵢ, Cᵢ, DNSᵢ), Gᵢ(Tyᵢ, Vdᵢ, Csᵢ, Atᵢ, Phᵢ), Dᵢ(Dmᵢ, Dgᵢ), Meᵢ(Tpᵢ), Rᵢ(Nmᵢ, Adsᵢ, Rpᵢ(Charᵢ))], f[Atnᵢ], f[Atcᵢ], f[Atdᵢ], f[Atrᵢ], f[Atrpᵢ], f[Atteᵢ], f[Atmeₗ]

*Red—has been determined and on to the next phase

FIG. 9—illustrates a systems architecture for establishing the legitimacy of adding a gift including fundamental data on predicting the gift: recipient buying habits, social media input, recipient profile and current trends. A calculation is made from that data and meta-data which is fed into an engine that has fundamental data about gift appropriateness: information about recipient, legality of gift, and type of gift. That result is sent to an alert engine and if it is above a certain threshold then an alert is sent. The result is also sent to a compound alert engine that takes into account all the resulting functions for each of the twelve steps and if that results in a situation above a certain threshold then an alert is issued from the compound engine.

The input to this legitimacy of adding a gift is depicted as a function.

### Input—Phase 7

Fmᵢ[Mᵢ(Tᵢ, Pᵢ, Vᵢ, Aᵢ, Muᵢ,Tmᵢ, Evᵢ),Uᵢ(Nᵢ, Adᵢ),Teᵢ(Ipᵢ, Dvᵢ, Lᵢ, Cᵢ, DNSᵢ), Gᵢ(Tyᵢ, Vdᵢ, Csᵢ, Atᵢ, Phᵢ), Dᵢ(Dmᵢ, Dgᵢ), Meᵢ(Tpᵢ), Rᵢ(Nmᵢ, Adsᵢ, Rpᵢ(Charᵢ))], f[Atnᵢ], f[Atcᵢ], f[Atdᵢ], f[Atrᵢ], f[Atrpᵢ], f[Atteᵢ], f[Atmeᵢ]

The output to this legitimacy of adding a gift is depicted as a function.

### Output—Phase 7

Fmᵢ[Mᵢ(Tᵢ, Pᵢ, Vᵢ, Aᵢ, Muᵢ,Tmᵢ, Evᵢ),Uᵢ(Nᵢ, Adᵢ),Teᵢ(Ipᵢ, Dvᵢ, Lᵢ, Cᵢ, DNSᵢ), Gᵢ(Tyᵢ, Vdᵢ, Csᵢ, Atᵢ, Phᵢ), Dᵢ(Dmᵢ, Dgᵢ), Meᵢ(Tpᵢ), Rᵢ(Nmᵢ, Adsᵢ, Rpᵢ(Charᵢ))], f[Atnᵢ], f[Atcᵢ], f[Atdᵢ], f[Atrᵢ], f[Atrpᵢ], f[Atteᵢ], f[Atmeᵢ], f[Atgᵢ]

*Red—has been determined and on to the next phase

FIG. 10—illustrates a systems architecture for establishing the legitimacy of scheduling a gift including fundamental data on the gift evaluated for terrorism, cyberbullying and child protection: history of past sent items, transportation schedule, legal documents, climate conditions, shelf life, vendor fulfillment and data entered. A calculation is made from that data and meta-data which is fed into an engine that has fundamental data: relationship between sender and recipient, date in history and world news. That result is sent to an alert engine and if it is above a certain threshold then an alert is sent. The result is also sent to a compound alert engine that takes into account all the resulting functions for each of the twelve steps and if that results in a situation above a certain threshold then an alert is issued from the compound engine.

The input to this legitimacy of scheduling a gift is depicted as a function.

### Input—Phase 8

Fmᵢ[Mᵢ(Tᵢ, Pᵢ, Vᵢ, Aᵢ, Muᵢ,Tmᵢ,Evᵢ),Uᵢ(Nᵢ, Adᵢ),Teᵢ(Ipᵢ, Dvᵢ, Lᵢ, Cᵢ, DNSᵢ), Gᵢ(Tyᵢ, Vdᵢ, Csᵢ, Atᵢ, Phᵢ), Dᵢ(Dmᵢ, Dgᵢ), Meᵢ(Tpᵢ), Rᵢ(Nmᵢ, Adsᵢ, Rpᵢ(Charᵢ))], f[Atnᵢ], f[Atcᵢ], f[Atdᵢ], f[Atrᵢ], f[Atrpᵢ], f[Atteᵢ], f[Atmeᵢ], f[Atmeᵢ], f[Atgᵢ]

The output to this legitimacy of scheduling a gift is depicted as a function.

### Output—Phase 8

Fmᵢ[Mᵢ(Tᵢ, Pᵢ, Vᵢ, Aᵢ, Muᵢ,Tmᵢ,Evᵢ),Uᵢ(Nᵢ, Adᵢ),Teᵢ(Ipᵢ, Dvᵢ, Lᵢ, Cᵢ, DNSᵢ), Gᵢ(Tyᵢ, Vdᵢ, Csᵢ, Atᵢ, Phᵢ), Dᵢ(Dmᵢ, Dgᵢ), Meᵢ(Tpᵢ), Rᵢ(Nmᵢ, Adsᵢ, Rpᵢ(Charᵢ))], f[Atnᵢ], f[Atcᵢ], f[Atdᵢ], f[Atrᵢ], f[Atrpᵢ], f[Atteᵢ], f[Atmeᵢ], f[Atgᵢ], f[Atdᵢ]

*Red—has been determined and on to the next phase

FIG. 11—illustrates a systems architecture for establishing the legitimacy of archiving a gift including fundamental data on the type of gift for retail: gift item, storage for gift, price of gift, delivery mechanism; for money: amount collected, banking institute to go to, interest, amount, bank ID, security, payment type, sender; gift certificate: vendor to be redeemed from, vendor card purchased from, amount of gift card. A calculation is made from that data and meta-data which is fed into an engine that has fundamental data: labor, climate, world events and regulations. That result is sent to an alert engine and if it is above a certain threshold then an alert is sent. The result is also sent to a compound alert engine that takes into account all the resulting functions for each of the twelve steps and if that results in a situation above a certain threshold then an alert is issued from the compound engine.

The input to this legitimacy of archiving a gift is depicted as a function.

### Input—Phase 9

Fmᵢ[Mᵢ(Tᵢ, Pᵢ, Vᵢ, Aᵢ, Muᵢ,Tmᵢ,Evᵢ),Uᵢ(Nᵢ, Adᵢ),Teᵢ(Ipᵢ, Dvᵢ, Lᵢ, Cᵢ, DNSᵢ), Gᵢ(Tyᵢ, Vdᵢ, Csᵢ, Atᵢ, Phᵢ), Dᵢ(Dmᵢ, Dgᵢ), Meᵢ(Tpᵢ), Rᵢ(Nmᵢ, Adsᵢ, Rpᵢ(Charᵢ))], f[Atnᵢ], f[Atcᵢ], f[Atdᵢ], f[Atrᵢ], f[Atrpᵢ], f[Atteᵢ], f[Atmeᵢ], f[Atgᵢ], f[Atdᵢ]

The output to this legitimacy of archiving a gift is depicted as a function.

### Output—Phase 9

Fmᵢ[Mᵢ(Tᵢ, Pᵢ, Vᵢ, Aᵢ, Muᵢ,Tmᵢ,Evᵢ),Uᵢ(Nᵢ, Adᵢ),Teᵢ(Ipᵢ, Dvᵢ, Lᵢ, Cᵢ, DNSᵢ), Gᵢ(Tyᵢ, Vdᵢ, Csᵢ, Atᵢ, Phᵢ), Dᵢ(Dmᵢ, Dgᵢ), Meᵢ(Tpᵢ), Rᵢ(Nmᵢ, Adsᵢ, Rpᵢ(Charᵢ))], f[Atnᵢ], f[Atcᵢ], f[Atdᵢ], f[Atrᵢ], f[Atrpᵢ], f[Atteᵢ], f[Atmeᵢ], f[Atgᵢ], f[Atdᵢ], Rgᵢ(Gᵢ, Stᵢ, Vᵢ, Csᵢ, Vdᵢ), GCᵢ(Amᵢ, Vdpᵢ, Vdsᵢ), Bnkᵢ(Amᵢ, Inᵢ, Scᵢ, Bidᵢ), Sycᵢ(Amᵢ, Rᵢ, Pmᵢ, Bidᵢ), f[Atgaᵢ]

*Red—has been determined and on to the next phase

FIG. 12—illustrates a systems architecture for establishing the legitimacy of archiving the message including fundamental data on the message evaluated for terrorism, cyberbullying and child protection: world events, currencies, financial crisis social media, social information, past medical records, relationship between sender and recipient, genetic information, past purchasing history and likes and dislikes. A calculation is made from that data and meta-data which is fed into an engine that has fundamental data: message in our system, primary Stewart System, secondary Stewart System, third Stewart System and fourth Stewart System. That result is sent to an alert engine and if it is above a certain threshold then an alert is sent. The result is also sent to a compound alert engine that takes into account all the resulting functions for each of the twelve steps and if that results in a situation above a certain threshold then an alert is issued from the compound engine.

The input to this legitimacy of archiving the message is depicted as a function.

### Input—Phase 10

Fmᵢ[Mᵢ(Tᵢ, Pᵢ, Vᵢ, Aᵢ, Muᵢ,Tmᵢ,Evᵢ),Uᵢ(Nᵢ, Adᵢ),Teᵢ(Ipᵢ, Dvᵢ, Lᵢ, Cᵢ, DNSᵢ), Gᵢ(Tyᵢ,Vdᵢ, Csᵢ, Atᵢ, Phᵢ), Dᵢ(Dmᵢ, Dgᵢ), Meᵢ(Tpᵢ), Rᵢ(Nmᵢ, Adsᵢ, Rpᵢ(Charᵢ))], f[Atnᵢ], f[Atcᵢ], f[Atdᵢ], f[Atrᵢ], f[Atrpᵢ], f[Atteᵢ], f[Atmeᵢ], f[Atgᵢ], f[Atdᵢ], Rgᵢ(Gᵢ, Stᵢ, Vᵢ, Csᵢ, Vdᵢ), GCᵢ(Amᵢ, Vdpᵢ, Vdsᵢ), Bnkᵢ(Amᵢ, Inᵢ, Scᵢ, Bidᵢ), Sycᵢ(Amᵢ, Rᵢ, Pmᵢ, Bidᵢ), f[Atgaᵢ]

The output to this legitimacy of archiving the message is depicted as a function.

### Output—Phase 10

Fmᵢ[Mᵢ(Tᵢ, Pᵢ, Vᵢ, Aᵢ, Muᵢ,Tmᵢ,Evᵢ),Uᵢ(Nᵢ, Adᵢ),Teᵢ(Ipᵢ, Dvᵢ, Lᵢ, Cᵢ, DNSᵢ), Gᵢ(Tyᵢ, Vdᵢ, Csᵢ, Atᵢ, Phᵢ), Dᵢ(Dmᵢ, Dgᵢ), Meᵢ(Tpᵢ), Rᵢ(Nmᵢ, Adsᵢ, Rpᵢ(Charᵢ))], f[Atnᵢ], f[Atcᵢ], f[Atdᵢ], f[Atrᵢ], f[Atrpᵢ], f[Atteᵢ], f[Atmeᵢ], f[Atgᵢ], f[Atdᵢ], Rgᵢ(Gᵢ, Stᵢ, Vᵢ, Csᵢ, Vdᵢ), GCᵢ(Amᵢ, Vdpᵢ, Vdsᵢ), Bnkᵢ(Amᵢ, Inᵢ, Scᵢ, Bidᵢ), Sycᵢ(Amᵢ, Rᵢ, Pmᵢ, Bidᵢ), f[Atgaᵢ], f[Stwᵢ], f[Atmaᵢ]

*Red—has been determined and on to the next phase

FIG. 13—illustrates a systems architecture for establishing the legitimacy of sending the message/gift including fundamental data on the message and/or gift if method of sending is available: significance of date, world events. A calculation is made from that data and meta-data which is fed into an engine that has fundamental data if method of sending is not available: calculate alternative recipient, calculate alternative method of sending, date history, world news. That result is sent to an alert engine and if it is above a certain threshold then an alert is sent. The result is also sent to a compound alert engine that takes into account all the resulting functions for each of the twelve steps and if that results in a situation above a certain threshold then an alert is issued from the compound engine.

The input to this legitimacy of sending the message/gift is depicted as a function.

### Input—Phase 11

Fmᵢ[Mᵢ(Tᵢ, Pᵢ, Vᵢ, Aᵢ, Muᵢ,Tmᵢ,Evᵢ),Uᵢ(Nᵢ, Adᵢ),Teᵢ(Ipᵢ, Dvᵢ, Lᵢ, Cᵢ, DNSᵢ), Gᵢ(Tyᵢ, Vdᵢ, Csᵢ, Atᵢ, Phᵢ), Dᵢ(Dmᵢ, Dgᵢ), Meᵢ(Tpᵢ), Rᵢ(Nmᵢ, Adsᵢ, Rpᵢ(Charᵢ))], f[Atnᵢ], f[Atcᵢ], f[Atdᵢ], f[Atrᵢ], f[Atrpᵢ], f[Atteᵢ], f[Atmeᵢ], f[Atgᵢ], f[Atdᵢ], Rgᵢ(Gᵢ, Stᵢ, Vᵢ, Csᵢ, Vdᵢ), GCᵢ(Amᵢ,Vdpᵢ, Vdsᵢ), Bnkᵢ(Amᵢ, Inᵢ, Scᵢ, Bidᵢ), Sycᵢ(Amᵢ, Rᵢ, Pmᵢ, Bidᵢ), f[Atgaᵢ], f[Stwᵢ], f[Atmaᵢ]

The output to this legitimacy of sending the message/gift is depicted as a function.

### Output—Phase 11

Fmᵢ[Mᵢ(Tᵢ, Pᵢ, Vᵢ, Aᵢ, Muᵢ,Tmᵢ,Evᵢ),Uᵢ(Nᵢ, Adᵢ),Teᵢ(Ipᵢ, Dvᵢ, Lᵢ, Cᵢ, DNSᵢ), Gᵢ(Tyᵢ,Vdᵢ, Csᵢ, Atᵢ, Phᵢ), Dᵢ(Dmᵢ, Dgᵢ), Meᵢ(Tpᵢ), Rᵢ(Nmᵢ, Adsᵢ, Rpᵢ(Charᵢ))], f[Atnᵢ], f[Atcᵢ], f[Atdᵢ], f[Atrᵢ], f[Atrpᵢ], f[Atteᵢ], f[Atmeᵢ], f[Atgᵢ], f[Atdᵢ], Rgᵢ(Gᵢ, Stᵢ, Vᵢ, Csᵢ, Vdᵢ), GCᵢ(Amᵢ, Vdpᵢ,Vdsᵢ), Bnkᵢ(Amᵢ, Inᵢ, Scᵢ, Bidᵢ), Sycᵢ(Amᵢ, Rᵢ, Pmᵢ, Bidᵢ), f[Atgaᵢ], f[Stwᵢ], f[Atmaᵢ], f[Atdᵢ], Rd(Rdmᵢ, Rdgᵢ)

### Output—Phase 12

Fmᵢ[Mᵢ(Tᵢ, Pᵢ, Vᵢ, Aᵢ, Muᵢ,Tmᵢ, Evᵢ), Uᵢ(Nᵢ, Adᵢ) Gᵢ(Tyᵢ,Vdᵢ, Csᵢ, Atᵢ, Phᵢ), Rᵢ(Nmᵢ, Adsᵢ), Rgᵢ(Gᵢ, Stᵢ, Vᵢ, Csᵢ,Vdᵢ), GCᵢ(Amᵢ,Vdpᵢ,Vdsᵢ), Bnkᵢ(Amᵢ, Inᵢ, Scᵢ, Bidᵢ), Sycᵢ(Amᵢ, Rᵢ, Pmᵢ, Bidᵢ), Rdᵢ(Rdmᵢ, Rdgᵢ)

*Red—has been determined and on to the next phase

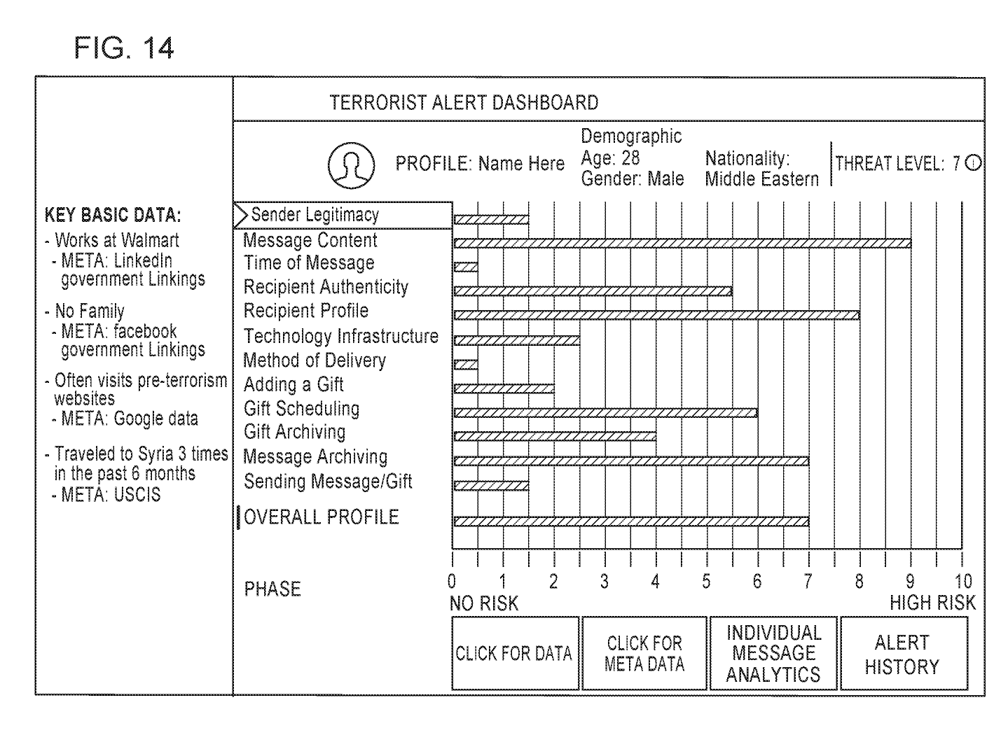

FIG. 14—Example of an Automatic, Customizable, Forensic Analysis of Alerted Situation

Situational Example of an Automatic, Customizable, Forensic Analysis of Altered Situation for Terrorism Recruitment:
1. Machine gathers information on sender and their activities
2. Machine reports following Sender Characteristics: Age 28, Male, Middle Eastern
Ethnicity, Works at Walmart, No Family, often visits pro-terrorism, Traveled to Syria 3 times in the past 6 months, Influx of bank deposits from foreign accounts.
3. Machine receives other data on sender, for example, tips from neighbors regarding suspicious activity and gatherings at odd times, including chanting and group rituals.
4. Machine gathers meta data; data regarding the tipsters, for example, the relation the tipster has with the sender. This leads to the determination of the quality of the tip
5. Machine runs correlation engine that forms a phase alert
6. Machine then gathers information regarding the recipient and their activities
7. Machine reports following Recipient Characteristics: Age 22, Male, US Nationality, Middle Eastern Descendent, Orphan, Vocal Pro-terrorism posts on Twitter, Phone calls to blocked/unknown numbers, Selling/Giving away living essentials on the internet, foreign bank deposits made from various countries.
8. Machine receives other data on sender, for example, tips from neighbors regarding suspicious activity and gatherings at odd times, including chanting and group rituals.
9. Machine gathers meta data; data regarding the tipsters, for example, the relation the tipster has with the sender. This leads to the determination of the quality of the tip
10. Machine runs correlation engine that forms a phase alert
11. Machine processes phase alerts with their respective weighting to form and then send a System Alert along with relevant information to the appropriate authorities
12. If appropriate, an alert is sent to the authorities
13. If not response, the alert is escalated

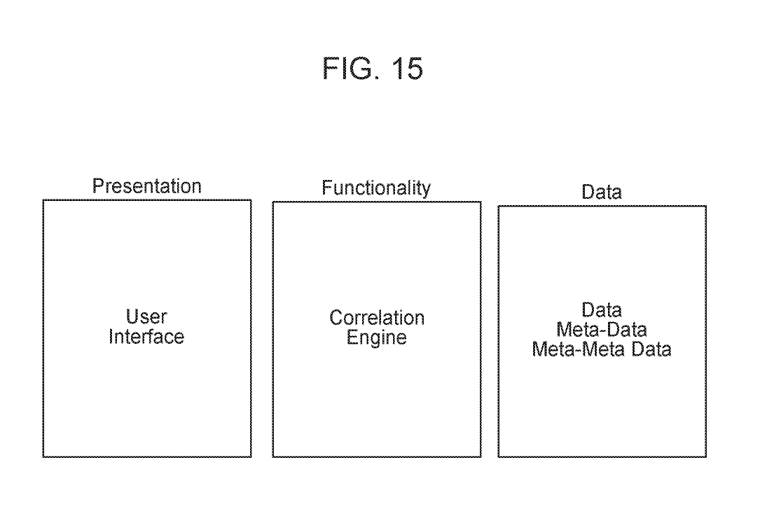

FIG. 15—Example of Three-Tier Implementation Architecture for Analysis/Correlation, Alert Engine, and Authentication and Reputation Database Components.

Presentation Layer—User Interface of the machine which includes the profile dashboard which is comprised of the User Profile. This is also a gateway to more information by displaying the functionality of the machine and links to more in-depth data, meta-data, and meta meta-data.

Functionality Layer—Servers that analyze and correlate multiple weighted data points and trends using algorithms specially designed for the engine. This correlation engine sends the correct gathered data to the appropriate authorities depending on threat level. This information is presented using Presentation Layer (User Interface).

Data Layer—This layer of the machine collects and archives all basic data, meta-data and meta-meta data for analytics. All of these types of data are constantly updated to provide the most accurate and up to date information to the functionality layer (correlation engine).

Inventions

Below there are five equations to explain how this data gathering and analyzing creates a System Alert. To start, meta-data needs to be gathered and meta-data on that meta-data needs to be analyzed in order to start summating the level of danger someone might possess. After the meta-data on meta-data is analyzed, the whole meta-data is looked upon, with this new scope. Later, this itself is analyzed and summated with all the other analyzed meta-data to create the level of alert that each phase carries.

### Hints Engine

Equation 1 below expresses how a Hint in Phase 1 is created. The equation takes the overall sum of: the data related to Phase 1 times its weight, the meta data related to Phase 1 times its weight and the meta-meta data related to Phase 1 times its weight. The weighing is predicated based on the importance of each meta-data and the reliability of the source. The equation summates this to create a System Alert coefficient, referred to as Hint. This Hint coefficient is carried throughout the system.

$$Hints = {\sum }_{i = 1}^{n} ( {W}_{x} {D}_{i} + {W}_{y} {MD}_{i} + {W}_{z} {MM}_{i} ) \qquad Equation 1$$

Where:
Hints=The weighted summation of data, meta-data and meta-meta-data regarding a single meta data point
Dᵢ=Data related to the phase in the overall process flow (Data can be behavioral—Such as activity on twitter, one or zero or factual-age)
Wᵢ=Weighting of Dᵢ based on the importance and reliability of source of data for data on Phase 1
MDᵢ=Meta-data related to the data in phase in the overall process flow
W_{y}=Weighting of MDᵢ based on the importance and reliability of source of meta data for data on Phase 1
MMᵢ=Meta-data related to the meta-data in phase in the overall process flow
W_{Z}=Weighting of MMᵢ based on the importance and reliability of source of meta meta data for data on Phase 1

From this equation:

Hints=Hᵢ

Examples of weighting would be on a percentage scale: if the meta-data on meta-data says that the sender has planned past terror attacks in the past the weight given would very high since this is an extremely important piece of information to create an alert.

An instance of this equation would be:
1) Machine gathers data on the sender, for Example: Age 22
2) Machine then gathers data on data (meta-data) regarding source of Age information. For Example: Age 22 was gathered from individual's Facebook page
3) Machine analyzes how reliable the source of the information is, gathering data on the meta-data (meta-meta-data). For Example: Since people can easily lie about age on Facebook, the data would not be as reliable.
4) Machine would weight each of these occurrences and aggregate them under a “Social Media Hint”

### Phase Alert Engine

Equation 2 below expresses how a Phase Alert is created. The equation takes the summation gathered from weighted meta-data on meta-data related to meta-data in each Phase in the Overall Process Flow and weighs it. The weighting is predicated on the importance of each meta-data and the reliability of the source. The equation summates this to create a System Alert coefficient, Phase Alert. When this coefficient reaches a high level, an alert is set and sent to the appropriate authorities. The Phase Alert is carried throughout the system.

$$Phase Alert = {\sum }_{i = 1}^{n} {H}_{i} {Y}_{i} \qquad Equation 2$$

Where:
Phase Alert=The summation of weighted meta data within a Phase in the Overall Process Flow.
Hᵢ=The summation of weighted meta-data on meta-data related to the phase in the overall process flow. The weighting of this meta-data examines the importance of meta-data and reliability of source.
Yᵢ=Weighting of Hᵢ based on the importance and reliability of source for the meta data on Phase 1.

From this equation:

Phase Alert=Pᵢ

Examples of weighting would be on a scale of 1 to 10, if the source of meta-data, criminal history of sender, was the FBI, the weight given would very high since this is an extremely reliable source.

An instance of this equation would be:
1) Machine gathers Hints regarding the legitimacy of the sender. For example, the sender could easily lie about their age.
2) Machine takes Hints and weights their importance to form a Phase Alert. For example, with the Hints gathered from Step 1, the machine will create a mid-level priority phase alert as the weight of Hints is prominent in terms of Terrorism.

### System Alert Engine

Equation 3 below expresses how a System Alert is created. The equation takes the summation gathered from weighted meta-data from each phase and weights it according to importance and reliability for each phase. The equation summates this to create a System Alert coefficient. When this coefficient reaches a high level, an alert is set and sent to the appropriate authorities.

$$System Alert = {\sum }_{i = 1}^{n} {P}_{i} {W}_{i} \qquad Equation 3$$

Where:
System Alert=The summation of weight phase alerts.
Pᵢ=The summation of weighted meta-data related to each Phase in the overall process flow. The weighting of this meta-data examines the importance of meta-data and reliability of source.
Wᵢ=Weighting of Pᵢ based on the importance and reliability of source of each Phase in the whole Overall Process Flow.

From this equation:

System Alert=SAᵢ

Examples of weighting would be on a scale of 1 to 10 (PERCENTAGE SCALE), the importance of an alert from Phase 1: Establishing the Legitimacy of Sender, would be weighted very high since an illegitimate sender should be an alert.

An instance of this equation would be:
1) Machine gathers Phase Alerts within the Overall Process Flow
2) Machine finds that the sender is not legitimate, the sender is trying to send gifts on important dates, the sender is trying to send illegal gifts, the sender is trying to send pro-terrorism messages and etc. For Example, a sender with an unverified age tries to send fireworks as gifts on 9/11/2017 with a suspicious message.
3) Machine takes Phase Alerts and weights their importance to form a System Alert. For example, with the finds from Step 2, the machine will create a high priority System Alert as the weight of the Phase Alerts are extremely prominent in terms of Terrorism.

Possible types of data included in Phase 1 expressed below:

| Data | Meta Data | Meta Meta Data |
|---|---|---|
| Sex of sender (Ex. Male) | Source of Sex Information | Reliability of the Source |
| | and its Reliability | of the Sex Information |
| | (Ex. Facebook) | (Ex. Facebook |
| | | is easily editable- |
| | | not validated) |
| Criminal History | Source of Criminal | Reliability of the Source |
| | History | of Criminal History |
| Ethnic Background | Source of Ethnic | Reliability of the Source |
| | Background | of Ethnic Background |
| Past history on sites | Source of past history on | Reliability of the Source |
| | sites | of Past History |
| Age of sender | Source of age information | Reliability of the Source |
| | | of Age Information |
| Sender's location | Source of sender location | Reliability of the Source |
| | | of Sender Location |
| Recent lawsuits | Source of lawsuits | Reliability of the Source |
| | | of Lawsuit Information |
| Relationship to Recipient | Source of relationship | Reliability of the Source |
| | information | of Relationship Information |
| Ties with Terrorism | Source of terrorism ties | Reliability of the Source |
| | information | of terrorism ties information |
| Tips | Source of Tips | Reliability of the Source |
| | | of Tips |
| Access Device | Source of Device | Reliability of the Source |
| | | of Device |
| Location of Device | Source of Device Location | Reliability of the Source |
| | | of Device Location |
| Servers Used | Source of Servers Used | Reliability of the Source |
| | | of Servers Used |
| Browsing History | Source of Browsing | Reliability of the Source |
| | History | of Browsing History |
| Social Networking | Source of Social | Reliability of the Source |
| | Networking | of Social Networking |
| Buying Habits | Source of Buying Habits | Reliability of the Source |
| | | of Buying Habits |
| Travel History | Source of Travel History | Reliability of the Source |
| | | of Travel History |
| Dates of Crimes | Source of Crimes | Reliability of the Source |
| Committed | Information | of Crimes Information |
| Types of Crimes | Source of Crimes | Reliability of the Source |
| Committed | Information | of Crimes Information |
| History after Crime | Source of Crimes | Reliability of the Source |
| | Information | of Crimes Information |

### Holistic User Threat Profile Database Engine

Equation 4 below expresses how all the data collected and created through the Machine is used to create a historical holistic database of user profiles depicting threat patterns. The equation summates this to create a unique holistic user threat profile database to ensure constant following of users and their possible threats to ensure the system is constantly improving and learning based on the more data that is collected or created.

Holistic User Threat Profile Databaseₜ=[[Uₙ(D_{n,t,c})]+[Rₐ(D_{a,t+delta,c}]+SAₜ] Equation 4

*Note: Detla T—Takes Time into Concideration

Where:
n=User ID
a=Recipient ID
U=User/Sender
R=Recipient
D=Data
t=time
HU=Holistic User Threat Profile Database
c=Categorize System Alert

An instance of this equation would be:
1) Machine gathers all data regarding Sender, including messages, gifting, recipients, dates, and etc.
2) Machine adds all the data collected and analyzed to a Holistic User Threat Profile database. This database is filled with all previous/past user data points and threat levels.
3) Machine creates the Holistic User Threat Profile based on the data collected and analyzed.
4) Machine constantly updates these databases as time progresses and more data is collected.

### Escalation Engine

Equation 5 below expresses how a System Alert transitions through the Escalation Engine to determine where the system alert is sent. The equation takes the summation gathered from the System Alert with their weighting and determines the intended receiver of this Alert based on importance and reliability. The equation summates this to create a destination for the System Alert to ensure the alert is set and sent to the appropriate authorities. The escalation engine creates and determines a hierarchy of authorities. When an alert is sent to the authority, if no or an inadequate response is received, the machine will move up the hierarchal ladder, sending a new alert (including information regarding previous, lack or inadequate response) until an adequate response has been received.

Escalated Alert=[Uₙ(D_{n,t,c},HUₙ)]+[Rₐ(D_{a,t+delta,c},HUₐ] Equation 5

Where:

Escalated Alert=The System Alert ranked according to Importance and Relevance
n=User ID
a=Recipient ID
U=User/Sender
R=Recipient
D=Data
t=time
HU=Holistic User Threat Profile Database
c=Categorize System Alert

From this equation:

Escalated Alert=EAᵢ
Steps:
   1) Escalation Alert Engine would analyze the System Alert (SA) Threat Level.
   2) If threat level is high enough, it would gather information to know which type of threat it is.
      a. Based on type of threat, it would identify the corresponding authority figures that would need to be contacted and would attach relevant information for the respecting authority figure.
   3) If threat level is lower than significant, no Escalated Alert is sent.
   4) Any and all outputs from the Escalation Alert Engine are sent to the Holistic User Threat Profile Database.

An instance of this equation would be:
1) System Alert returned a 94% confidence of possible threat by Sender
2) Escalation Alert Engine recognizes the system alert as high enough and recognizes it as a terrorist treat based on finding that ingredients used to make bombs were being sent on significant dates along with messages used for plotting terrorist attacks.
3) Based on the high threat level and type of threat (terrorism), the Escalation Alert Engine sends Sender, Recipient and Message/Gift Data to top officers at Homeland Security.
5) If there no or an inadequate response received, the system repeats itself and will send the alert through the escalation engine and will be sent to the next higher level of authority.

### Definitions

1) As used herein, the term “Basic Data” shall refer to concrete quantitative/qualitative data regarding either the Sender/Recipient personal information
2) As used herein, the term “Social Networks” shall refer to an online network which allows for communication and connectivity between individuals, for example, Facebook, Twitter, Pinterest, Instagram, Snapchat, YouTube, symphony, blogs, or services like SendItLater.
3) As used herein, “Correlated Events” shall include primitive and/or compound events that have been correlated across either data, devices, meta-data, servers, space or time. An example of a correlated event is a change in or of device (including IP device) attributes.
4) As used herein, the term “Attribute Data” shall designate data about devices or sources (such as DNS data), such as the quality of the data produced by the devices, the age of the devices or data, time since the devices or data were last maintained, integrity of the devices or data, reliability of the devices or data, and so on. Mutually exclusive. Attribute data has associated weights.
5) As used herein, the term “Tips”, attribute data refers to data about the source of the tips. For example, a tip from an anonymous submitter will have different weights corresponding to the attribute data than a tip submitted by a law enforcement officer.
6) As used herein, the term “Contextual Attribute Data” shall refer to data stored and corresponds to the attribute data of the device that captured the data. For example, the meta-data is stored with memorialization of the same context of that data and meta-data.
7) As used herein, the term “Meta-data” and “Attribute Data” are both used for event correlation, for network management, and detection of vulnerabilities.
8) As used herein, the term “Meta-data” shall refer to data about data (primitive events, compound events, correlated events, etc.). Meta-data in the form of primitive events is used to detect compound events of higher value. Primitive and compound events are correlated across space and time to generate additional meta-data of even higher value. The events are weighted according to the attribute data corresponding to the devices that generated the events. Primitive, compound, and correlated events may trigger one or more intelligent alerts to one or more destinations. The meta-data is also used for forensic analysis to search and retrieve data by event. Examples of meta-data include primitive events, (including changes in DNS, network paths, device identification), compound events, meta-data extracted from independent tips, network events, device information, and external information provided by government and law enforcement and other consortium. Meta-data also includes compound events and correlated events, defined below. Meta-data also includes information added manually by a human reviewer, such as a person who reviews tips and reports.
9) As used herein, the term “Cloud” shall refer to- from the viewpoint of the sender it is a general utility that handles all storage for sender applications, software and hardware needs. The sender may be charged by the transaction.
10) As used herein, the term “Hosting” shall refer to- from the viewpoint of the hosting provider is a collection of servers, mainframes, storage units, the internet, all of the hardware and software to host multiple applications
11) As used herein, the term “Phases” shall refer to the different steps on which the overall architecture makes the overall process flow go through
12) As used herein, the term “Hints” shall refer to the weighted summation of data, meta-meta data regarding a single meta data point
13) As used herein, the term “Meta Meta Data” shall refer to data about meta data
14) As used herein, the term “Phase Alert” shall refer to the summation of weighted meta data within a Phase in the Overall Process Flow
15) As used herein, the term “Overall Process Flow” shall refer to the flow through which every phase passes
16) As used herein, the term “System Alert engine” shall refer to the alert system used to look at the different phases within the Overall Process Flow
17) As used herein, the term “Correlated engine” shall refer to an engine which looks as various events, finds important data that must be gathered, and check for similarities, correlations.
18) As used herein, the term “Holistic User Threat Profile Database” shall refer to the profile created for each sender and recipient that is comprised of data about them and their System Alert over time.
19) As used herein, the term “Hardware/Software vendors” shall refer to form the point of view the cloud is a new and changing market for hardware, software and consulting services, as cloud adoption grows need for self-fielded equipment will decline and need for hardware for the cloud service providers will increase.
20) As used herein, the term “DNS (Domain Name System)” shall refer to one of the largest databases in the world consisting of the information needed to traverse the pathways to devices and assets on the internet.
21) As used herein, the term “Primitive events” may be generated automatically by various devices, or may be generated in software based on data from various databases. In one embodiment, a human operator adds meta-data and thereby generates primitive events. For example, a human operator may add meta-data indicating, “Suspicious activity was observed at this location which houses servers.”

What is claimed is:

1. A method for detecting and mitigating bullying and terrorism over the internet, the method comprising:
establishing legitimacy of a sender and developing a profile for the sender
establishing legitimacy of package from the sender
establishing legitimacy of when the package is to be sent;
establishing authenticity of the recipient;
developing a recipient profile;
establishing authenticity of technology infrastructure being used to transport the package by providing a mechanism and judgment to determine ongoing veracity of a recipient device using parameters including unique device id, history of access, paths taken or environmental data;
determining method of delivery of the package with a reputation database;
establishing legitimacy of a gift from the sender; and
archiving the gift in and determining appropriateness of gift in context of a relationship between the sender and the recipient.
